(19) United States
(12) Patent Application Publication
(10) Pub. No.: US 2023/0323505 A1
(43) Pub. Date: Oct. 12, 2023

(54) METHOD FOR EXTRACTION OF COINAGE METALS

(71) Applicant: Excir Works Corp, Calgary (CA)

(72) Inventors: Loghman MORADI, Calgary (CA); Hiwa SALIMI, Calgary (CA); Shawna Lynn NESDOLY, Calgary (CA); Jenna Kathleen BRATVOLD, Prince Albert (CA)

(21) Appl. No.: 18/026,921

(22) PCT Filed: Oct. 4, 2021
(86) PCT No.: PCT/CA2021/051385

§ 371 Date: Mar. 17, 2023

Related U.S. Application Data
(60) Provisional application No. 63/086,664, filed on Oct. 2, 2020.
(60) Provisional application No. 63/086,665, filed on Oct. 2, 2020.

(51) Int. Cl. C22B 3/08; C22B 7/00; C22B 15/00; C22B 11/00; C25C 1/12; C25C 1/20

(52) U.S. Cl. CPC C22B 3/08; C22B 7/007; C25C 1/20; C22B 11/04; C25C 1/12; C22B 15/0071

(57) ABSTRACT

Solutions and methods for leaching coinage metals. For example, Solutions and methods for leaching copper and/or silver from a substance comprising copper and/or silver (such as a coinage metal-concentrate, or electronic waste) using a water-miscible stabilizer in combination with leaching reagents to form leach solutions.

### CROSS-REFERENCE TO RELATED APPLICATIONS

This application claims priority to U.S. Provisional Application No. 63/086,664; U.S. 63/086,665; each filed Oct. 2, 2020, the entire contents of each of which is hereby incorporated by reference.

### FIELD

The present disclosure relates to methods for extraction of coinage metals. For example, the present disclosure relates to methods of leaching coinage metals from a substance comprising such coinage metals (such as a coinage metal-concentrate, coinage metal-containing ore, or electronic wastes) in the presence of a water-miscible stabilizer.

### BACKGROUND

Coinage metals are a group of elements in the periodic table that includes copper (Cu), silver (Ag), and gold (Au). The average concentration of Cu in Earth's crust is approximately 50 to 67 ppm, and the average concentration of Ag is approximately 0.07 ppm (parts per million). Ore deposits containing copper generally contain about 0.2% to 1.0% Cu; ore deposits containing silver may contain about 0.085% Ag. Principle sources of silver include copper ores, copper-nickel ores, gold ores, lead ores, and lead-zinc ores, from which approximately 26 000 to 27 000 tonnes of silver is produced.

Application of Coinage Metals

Coinage metals are used in a wide variety of areas due to their unique properties, such as high ductility, electrical and thermal conductivity, good wear-resistance, antimicrobial properties, and anti-corrosion properties. For example, coinage metals are so called because, historically, they have been used as components in minting coins. Further, coinage metals have been used in catalysis, jewelry-making, medicines, and in the electrical and electronics industry, amongst others.

Recovery of Coinage Metals from Ore

Extracting coinage metals from ore involves smelting, followed by hydrometallurgical refining. Generally, extraction, concentration and purification of coinage metals from natural deposits can be capital, time and energy intensive processes that result in significant amounts of solid and liquid wastes. An example of recovering coinage metals from ore involves crushing coinage metal-bearing substances and grinding them into fine particles. Froth flotation, as a wet chemical treatment, is then used to produce a concentrate which is further dried and smelted in an electric furnace at temperatures, e.g., over 1500° C. The out-coming solid may be leached acid, with the aqueous solution being further processed using hydrometallurgical techniques, such as solvent extraction, ion-exchange, and electrolysis to produce individual high purity metals.

Waste from Electrical and Electronic Equipment (WEEE) or Electronic Waste (E-Waste)

Advancing technologies and innovation has increased demand and production of electrical and electronic equipment (EEE), which in turn has increased generation of waste from electrical and electronic equipment (WEEE) or electronic waste (e-waste). For example, the global production of e-waste/WEEE includes upwards of 20 to 50 million tons per year of e-waste, and it is expected that these amounts will only increase.

Electrical and E-waste is generally classified as a hazardous material, examples of which include integrated circuit chips, printed circuit boards (PCBs), solder in PCBs, glass panels and gaskets in computer monitors, chip resistors and semiconductors, relays and switches, corrosion protection for untreated galvanized steel plates, decorator or hardener for steel housing, cabling and computer housing, plastic housing of electronic equipment and circuit boards, front panel of cathode ray tubes, motherboards, large/small household appliances, IT and telecommunications equipment, electrical and electronic tools, medical devices, lighting equipment, computer monitors, TVs, CPU/hard disk of computers, cables and wires, capacitors, and condensers. Such wastes often contain metals such as copper (Cu), silver (Ag), gallium (Ga), tantalum (Ta), tellurium (Te), germanium (Ge), and selenium (Se), which can make it viable for recycling. Generally, pyrometallurgical and hydrometallurgical processes are commonly employed to recover metals from such wastes.

Metallurgical Processes for the Extraction of Metals from E-Waste

Hydrometallurgical Processes

Extraction of metals from e-waste can involve hydrometallurgical routes that comprise the steps of acid or caustic leaching for selective dissolution of metals from e-waste e.g., using sulphuric acid, nitric acid, or aqua regia for leaching. Generally, the pregnant leach solution is then separated and purified for enrichment of metal content whereby impurities are removed as gangue materials. Isolating the metals can be conducted through solvent extraction, adsorption, and/or ion exchange enrichment processes; and recovery of the metals from solution can be conducted through electrorefining (electrometallurgy) or chemical reduction processes.

In a hydrometallurgical process, the waste or scrap containing coinage metals (for example, e-waste) is first pre-processed by manually dismantling and isolating individual components containing coinage metals. For example, the scrap may be shredded into pieces using hammer mills, and metals and non-metals separated using screening, magnetic, eddy current, and density separation techniques. Such screening processes allow for separation of an iron/steel fraction and an aluminum fraction from coinage metal-containing residue.

The coinage metal-containing fraction is then further processed using hydrometallurgical, pyrometallurgical, electrometallurgical, or biometallurgical processes, individually or in combination. For example, the processing may consist of solder leaching for separation of a non-metallic fraction and a solder recovery (electrowinning) fraction. The coinage metal-containing residue from the solder leaching is treated by an additional leaching step. The coinage metals are recovered from the leached solution by cementation, solvent extraction, adsorption on activated carbon, electrolysis, or ion exchange methods.

However, there are limitations to hydrometallurgical processes, such as: (i) being a slow and time consuming process; (ii) loss of metals during mechanical processing of waste; (iii) using corrosive or toxic chemicals, or chemicals that can produce corrosive or toxic chemical by-products, thereby requiring higher safety standards and protocols to avoid environmental contamination and human health risks; (iv) there being a risk of further loss of metal during subsequent dissolution and separation steps, which impacts the overall metal recovery.

Pyrometallurgical Processes

Pyrometallurgical techniques include conflagrating, smelting in a plasma arc furnace, drossing, sintering, melting, and varied reactions in a gas phase at high temperatures. Generally, pyrometallurgical processes include the steps of liberation, separation/upgrading, and purification, which are similar to those of hydrometallurgical processes. However, in contrast to hydrometallurgical processes, pyrometallurgical processes do not rely on leaching but rather smelting in furnaces at high temperatures. Coinage metals may therefore be sorted based on chemical and metallurgical properties. In respect of e-waste management and recycling, smelting in furnaces, incineration, combustion, and pyrolysis is generally used.

An example of a pyrometallurgical process is the lead smelting route, which involves sintering (ores), reduction, and refining stages. Sintering is carried out to reduce sulfur contents of feed materials. The reduction process is carried out in blast furnaces using coke, from which molten lead (85% purity) can be isolated. In the refining stage, metal and sulfur dross is separated and treated separately (e.g., in a reverberatory furnace). Heating lead dross in a reverberatory furnace leads to the separation of lead bullion (rich in lead), matte (copper and other metals sulfides) and speiss (high in arsenic and antimony contents), wherein the matte and speiss can be treated in copper smelters for the extraction of copper and other metals.

When processing e-waste by the lead smelting route, coinage metals and other elements are separated from the lead bullion. Some coinage metals can be separated by forming an insoluble intermetallic compound using zinc (e.g., the Parkes process).

Another example of a pyrometallurgical process involves copper smelting routes, which are used to recycle and extract coinage metals from e-waste. In copper smelting routes, other coinage metals are collected in copper matte or black copper. The copper and other metals are separated from each other via an electrorefining process that produces pure copper metal, with the other coinage being separated into slimes. The other coinage metals are then recovered from the slimes via hydrometallurgical routes.

Limitations of pyrometallurgical processes include: (i) not being able to recover and/or recycle plastics, as they are sometimes used in place of coke as a fuel source; (ii) reduced iron and aluminum recovery, as they end up as oxides in slag phases; (iii) generation of hazardous emissions, such as dioxins, during smelting of certain feed materials (e.g, halogenated flame retardants) requiring special installations to minimize environmental pollution; (iv) high costs of implementing integrated e-waste recycling plants that maximize recovery of valuable metals while also controlling hazardous gas emissions and protecting the environment; (v) burning of fine dust generated from non-metallic portions of e-wastes must be controlled and/or minimized to avoid the health risk posed by fine dust particles; (vi) only a partial recovery and purity of coinage metals are affected by pyrometallurgical routes, therefore requiring additional hydrometallurgical and electrochemical techniques to extract pure metals; and (vii) managing smelting and refining is challenging due to the complexity of feed materials and the thermodynamics of possible reactions.

### SUMMARY

The present disclosure describes the use of a water-miscible stabilizer in combination with leaching reagents to form aqueous leach solutions that may, for example, improve and/or simplify recovery of coinage metals from substances comprising such metals, and/or produce less waste.

Accordingly, in an aspect of the present disclosure, there is provided a method of leaching coinage metal from a substance comprising coinage metal, the method comprising contacting the substance with an aqueous leach solution comprising:
(a) a leaching acid;
(b) an oxidizing agent; and
(c) a water-miscible stabilizer,
under conditions to leach the coinage metal from the substance.

In one or more embodiments of the present disclosure, there is provided a method wherein the stabilizer is a water-miscible monocarboxylic acid or water-miscible polycarboxylic acid.

In one or more embodiments of the present disclosure, there is provided a method wherein the stabilizer is a water-miscible C₂-C₅ monocarboxylic acid. In an embodiment, the water-miscible monocarboxylic acid is acetic acid.

In one or more embodiments of the present disclosure, there is provided a method wherein the stabilizer is a water-miscible C₂-C₈ polycarboxylic acid. In an embodiment, the water-miscible polycarboxylic acid is citric acid.

In one or more embodiments of the present disclosure, there is provided a method wherein the stabilizer is about 1% to about 20% (vol/vol) of the leach solution.

In one or more embodiments of the present disclosure, there is provided a method wherein the leaching acid is an acid having a first pKₐ≤1, or <0. In one or more embodiments, the leaching acid is H₂SO₄, HNO₃, or a combination thereof. In an embodiment, the leaching acid is H₂SO₄. In an embodiment, the H₂SO₄ is at a concentration of about 1M to about 2M.

In one or more embodiments of the present disclosure, there is provided a method wherein the oxidizing agent is CuCl₂, FeCl₃, MnO₂, KMnO₄, H₂O₂, or a combination thereof. In an embodiment, the oxidizing agent is H₂O₂. In an embodiment, the H₂O₂ is about 1% to about 15% (vol/vol) of the leach solution.

In one or more embodiments of the present disclosure, the method further comprises:
separating the leach solution containing the leached coinage metal from insoluble impurities;
treating the leached coinage metal in the leach solution under conditions to obtain the coinage metal; and
separating the coinage metal from the leach solution.

In one or more embodiments of the present disclosure, there is provided a method wherein treating the leached coinage metal in the leach solution under conditions to obtain the coinage metal comprises reduction, electrowinning, ion exchange, metal-salt precipitation, or a combination thereof.

In one or more embodiments of the present disclosure, there is provided a method wherein the conditions to leach the coinage metal from the substance comprises contacting the substance comprising the coinage metal and the leach solution for a time of about 1 hour to about 6 hours at ambient temperature.

In one or more embodiments of the present disclosure, there is provided a method wherein the substance comprising coinage metal is a substance comprising copper and/or silver. In one or more embodiments, the substance comprising copper and/or silver further comprises gold, palladium, rhodium, and/or platinum, and the method selectively dissolves the copper and/or silver from the substance.

In one or more embodiments of the present disclosure, there is provided a method wherein the method further comprises leaching base metals and/or ferrous metals from the substance comprising coinage metal.

In one or more embodiments of the present disclosure, there is provided a method wherein the substance comprising coinage metal comprises ore deposits, coinage metal-concentrates, or electronic waste. In an embodiment, the electronic waste comprises integrated circuit chips.

In one or more embodiments of the present disclosure, there is provided a method wherein the leached coinage metal is copper. In one or more embodiments of the present disclosure, there is provided a method wherein the leached coinage metal is silver.

In another aspect of the present disclosure, there is provided an aqueous leach solution for use in leaching coinage metal from a substance comprising coinage metal, the solution comprising:
(a) a leaching acid;
(b) an oxidizing agent; and
(c) a water-miscible stabilizer.

In one or more embodiments of the present disclosure, there is provided a solution wherein the stabilizer is a water-miscible monocarboxylic acid or water-miscible polycarboxylic acid.

In one or more embodiments of the present disclosure, there is provided a solution wherein the stabilizer is a water-miscible C₂-C₅ monocarboxylic acid. In an embodiment, the water-miscible monocarboxylic acid is acetic acid.

In one or more embodiments of the present disclosure, there is provided a solution wherein the stabilizer is a water-miscible C₂-C₈ polycarboxylic acid. In an embodiment, the water-miscible polycarboxylic acid is citric acid.

In one or more embodiments of the present disclosure, there is provided a solution wherein the stabilizer is about 1% to about 20% (vol/vol) of the leach solution.

In one or more embodiments of the present disclosure, there is provided a solution wherein the leaching acid is an acid having a first pKₐ≤1, or <0. In one or more embodiments, the leaching acid is H₂SO₄, HNO₃, or a combination thereof. In an embodiment, the leaching acid is H₂SO₄. In an embodiment, the H₂SO₄ is at a concentration of about 1M to about 2M.

In one or more embodiments of the present disclosure, there is provided a solution wherein the oxidizing agent is CuCl₂, FeCl₃, MnO₂, KMnO₄, H₂O₂, or a combination thereof. In an embodiment, the oxidizing agent is H₂O₂. In an embodiment, the H₂O₂ is about 1% to about 15% (vol/vol) of the leach solution.

In one or more embodiments of the present disclosure, there is provided a solution wherein the substance comprising coinage metal is a substance comprising copper and/or silver. In one or more embodiments, the substance comprising copper and/or silver further comprises gold, palladium, rhodium, platinum, base metals, and/or ferrous metals.

In one or more embodiments of the present disclosure, there is provided a solution wherein the substance comprising coinage metal comprises ore deposits, coinage metal-concentrates, or electronic waste. In an embodiment, the electronic waste comprises integrated circuit chips.

In one or more embodiments of the present disclosure, there is provided a solution wherein the leached coinage metal is copper. In one or more embodiments of the present disclosure, there is provided a solution wherein the leached coinage metal is silver.

As herein described, there is also provided:

1. A method of leaching coinage metal from a substance comprising coinage metal, the method comprising contacting the substance with an aqueous leach solution comprising: (a) a leaching acid; (b) an oxidizing agent; and (c) a water-miscible stabilizer, under conditions to leach the coinage metal from the substance.
2. The method of item 1, wherein each of the leaching acid, oxidizing agent, and water-miscible stabilizer is a different chemical compound.
3. The method of item 1 or 2, wherein the stabilizer is a water-miscible carboxylic acid having a first pKₐ≥3.
4. The method of any one of items 1 to 3, wherein the stabilizer is a water-miscible monocarboxylic acid, water-miscible polycarboxylic acid, carboxylates thereof, or a combination thereof.
5. The method of any one of items 1 to 4, wherein the stabilizer is a water-miscible C₂-C₅ monocarboxylic acid, carboxylates thereof, or a combination thereof.
6. The method of item 5, wherein the water-miscible monocarboxylic acid is acetic acid, carboxylates thereof, or a combination thereof.
7. The method of any one of items 1 to 6, wherein the stabilizer is a water-miscible C₂-C₈ polycarboxylic acid, carboxylates thereof, or a combination thereof.
8. The method of item 7, wherein the water-miscible polycarboxylic acid is citric acid, carboxylates thereof, or a combination thereof.
9. The method of any one of items 1 to 8, wherein the stabilizer is <50% (vol/vol), or ≤20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the leach solution.
10. The method of any one of items 1 to 9, wherein the leaching acid is an acid having a first pKₐ≤1, or <0.
11. The method of any one of items 1 to 10, wherein the leaching acid is H₂SO₄, HNO₃, or a combination thereof.
12. The method of any one of items 1 to 11, wherein the leaching acid is H₂SO₄.
13. The method of item 12, wherein the H₂SO₄ is at a concentration of about 0.01M to about 5M, or about 0.01M to about 2M, or about 0.01M to about 1M, or about 0.01M to about 0.5M.
14. The method of any one of items 1 to 11, wherein the leaching acid is HNO₃ at a concentration of <2M, or about 1M to about 2M, or <1M.
15. The method of any one of items 1 to 14, wherein the leaching acid is not HNO₃.
16. The method of any one of items 1 to 15, wherein the oxidizing agent has a standard reduction potential of ≥0.6V, ≥0.65V or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or
17. The method of any one of items 1 to 16, wherein the oxidizing agent is CuCl₂, FeCl₃, MnO₂, KMnO₄, H₂O₂, Fe₂(SO₄)₃, or a combination thereof.
18. The method of any one of items 1 to 17, wherein the oxidizing agent is H₂O₂ or Fe₂(SO₄)₃, or combination thereof.
19. The method of any one of items 1 to 18, wherein the oxidizing agent is H₂O₂.
20. The method of item 19, wherein the H₂O₂ is about 1% to about 20% (vol/vol), or about 5% to about 15% (vol/vol), or about 10% to about 15% (vol/vol), or about 15% (vol/vol) of the leach solution.
21. The method of any one of items 1 to 18, wherein the oxidizing agent is Fe₂(SO₄)₃.
22. The method of item 21, wherein the Fe₂(SO₄)₃ is about 0.1% to about 5% (vol/vol), or about 0.1% to about 1% (vol/vol), or about 0.1% to about 0.5% (vol/vol), or about 0.3% (vol/vol) of the leach solution.
23. The method of any one of items 1 to 22, wherein the method further comprises: separating the leach solution containing the leached coinage metal from insoluble impurities; treating the leached coinage metal in the leach solution under conditions to obtain the coinage metal; and separating the coinage metal from the leach solution.
24. The method of item 23, wherein treating the leached coinage metal in the leach solution under conditions to obtain the coinage metal comprises reduction, electrowinning, ion exchange, metal-salt precipitation, or a combination thereof.
25. The method of item 23 or 24, wherein treating the leached coinage metal in the leach solution under conditions to obtain the coinage metal comprises electrowinning.
26. The method of any one of items 1 to 25, wherein the conditions to leach the coinage metal from the substance comprises contacting the substance comprising the coinage metal and the leach solution at ambient temperature and/or pressure.
27. The method of any one of items 1 to 25, wherein the conditions to leach the coinage metal from the substance comprises contacting the substance comprising the coinage metal and the leach solution at a temperature between about 20° C. to <80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.
28. The method of any one of items 1 to 27, wherein the conditions to leach the coinage metal from the substance comprises contacting the substance comprising the coinage metal and the leach solution at a solid to liquid ratio of about 1:4, or about 1:5, or about 1:6, or about or about 1:7, or about 1:8, or about 1:9, or about 1:10.
29. The method of any one of items 1 to 28, wherein the conditions to leach the coinage metal from the substance comprises contacting the substance comprising the coinage metal and the leach solution for a time of about 0.5 hours to about 6 hours, or about 1 hour to about 6 hours, or about 1 hour or about 3 hours, or about 1 hour to about 2 hours.
30. The method of any one of items 1 to 29, further comprising grinding the substance into particles having a size of 250 microns.
31. The method of any one of items 1 to 30, wherein the substance comprising coinage metal comprises ores, coinage metal-concentrates, mining concentrates (e.g., Cu and/or Ag mining concentrates), electronic waste, jewelry, automotive components, building components, tools, musical instruments, medical equipment, industrial machinery, soldering or brazing materials, soldered or brazed components, coins, solar panels, catalysts, mirror components, glass components, multilayer ceramic chip capacitor (MLCC), spent silver oxide batteries, or a combination thereof.
32. The method of any one of items 1 to 31, wherein the substance comprising coinage metal comprises ores, coinage metal-concentrates, mining concentrates, or electronic waste.
33. The method of item 32, wherein the electronic waste comprises electronic equipment or components thereof.
34. The method of any one of items 31 to 33, wherein the electronic waste comprises motherboards, chip resistors, chip semiconductors, printed circuit boards, integrated circuit chips, or a combination thereof.
35. The method of any one of items 1 to 34, wherein the substance comprising coinage metal is a substance comprising copper and/or silver.
36. The method of item 35, wherein the substance comprising copper and/or silver further comprises gold, palladium, rhodium, and/or platinum, and the method selectively dissolves the copper and/or silver from the substance.
37. The method of any one of items 1 to 36, further comprising leaching base metals and/or ferrous metals from the substance comprising coinage metal.
38. The method of any one of items 1 to 37, wherein the leached coinage metal is copper.
39. The method of any one of items 1 to 38, wherein the leached coinage metal is silver.
40. The method of any one of items 1 to 39, wherein the leached coinage metal is copper and silver.
41. The method of any one of items 1 to 40, further comprising regenerating the oxidizing agent.
42. The method of any one of items 1 to 41, wherein the oxidizing agent is regenerated in-situ, optionally for re-use of the aqueous leach solution.
43. The method of item 41 or 42, wherein the oxidizing agent is at least partially reduced and regenerating the oxidizing agent comprises contacting the at least partially reduced oxidizing agent with an aqueous oxidizing solution comprising: (a) an oxidant; (b) an acid; and (c) optionally a water-miscible stabilizer; under conditions to oxidize the at least partially reduced oxidizing agent to regenerate the oxidizing agent.
44. The method of item 43, wherein each of the oxidant, acid, and water-miscible stabilizer is a different chemical compound.
45. The method of item 43 or 44, wherein the oxidant has a first standard reduction potential (E^{O}₁), the oxidizing agent has a second standard reduction potential (E^{O}₂), and E^{O}₁>E^{O}₂.
46. The method of item 45, wherein oxidant has a standard reduction potential (E^{O}₁)≥0.6V, ≥0.65V, or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V.
47. The method of any one of items 43 to 46, wherein oxidant comprises FeCl₃, MnO₂, KMnO₄, H₂O₂, Fe₂(SO₄)₃, or any combination thereof
48. The method of item 47, wherein the oxidant is MnO₂, KMnO₄, H₂O₂, or a combination thereof.
49. The method of item 48, wherein the oxidant is H₂O₂.
50. The method of any one of items 43 to 49, wherein the acid is an acid having at least one pKₐ≤1, or <0.
51. The method of item 50, wherein the acid is H₂SO₄, HNO₃, or a combination thereof.
52. The method of item 51, wherein the acid is H₂SO₄.
53. The method of any one of items 43 to 52, wherein the stabilizer is a water-miscible carboxylic acid having a first pKₐ≥3.
54. The method of item 53, wherein the stabilizer is a water-miscible monocarboxylic acid, water-miscible polycarboxylic acid, carboxylates thereof, or a combination thereof.
55. The method of item 53 or 54, wherein the stabilizer is a water-miscible C₂-C₅ monocarboxylic acid, carboxylates thereof, or a combination thereof; wherein preferably the water-miscible monocarboxylic acid is acetic acid, carboxylates thereof, or a combination thereof.
56. The method of any one of items 53 to 55, wherein the stabilizer is a water-miscible C₂-C₈ polycarboxylic acid, carboxylates thereof, or a combination thereof; wherein preferably the water-miscible polycarboxylic acid is citric acid, carboxylates thereof, or a combination thereof.
57. The method of any one of items 43 to 56, wherein the conditions comprise contacting the at least partially reduced oxidizing agent with the aqueous oxidizing solution at ambient temperature and/or pressure.
58. The method of any one of items 43 to 57, wherein the conditions comprise contacting the at least partially reduced oxidizing agent with the aqueous oxidizing solution at a temperature between about 20° C. to about 80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.
59. The method of any one of items 43 to 58, wherein the conditions to oxidize the at least partially reduced oxidizing agent to regenerate the oxidizing agent comprise contacting the at least partially reduced oxidizing agent with the aqueous oxidizing solution for a time of about 1 min to about 1 hour, or about 5 min to about 45 min, or about 10 min to about 30 min.
60. A method of leaching coinage metal from a substance comprising coinage metal, the method comprising contacting the substance with an aqueous leach solution comprising: (a) H₂SO₄ as a leaching acid; (b) Fe₂(SO₄)₃, H₂O₂ or combination thereof as an oxidizing agent; and (c) acetic acid, citric acid, or a combination thereof as a water-miscible stabilizer, under ambient temperatures and/or pressures to leach the coinage metal from the substance.
61. The method of item 60, wherein the H₂SO₄ is at a concentration of about 0.01M to about 5M, or about 0.01M to about 2M, or about 0.01M to about 1M, or about 0.01M to about 0.5M.
62. The method of item 60 or 61, wherein the oxidizing agent is H₂O₂, preferably at about 1% to about 20% (vol/vol), or about 5% to about 15% (vol/vol), or about 10% to about 15% (vol/vol), or about 15% (vol/vol) of the leach solution.
63. The method of any one of items 60 to 62, wherein the oxidizing agent is Fe₂(SO₄)₃, preferably at about 0.1% to about 5% (vol/vol), or about 0.1% to about 1% (vol/vol), or about 0.1% to about 0.5% (vol/vol), or about 0.3% (vol/vol) of the leach solution.
64. The method of any one of items 60 to 63, wherein the stabilizer is <50% (vol/vol), or ≥20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the leach solution.
65. The method of any one of items 60 to 64, further comprising grinding the substance into particles having a size of 250 microns.
66. The method of any one of items 60 to 65, wherein the substance comprising coinage metal comprises ores, coinage metal-concentrates, mining concentrates (e.g., Cu and/or Ag mining concentrates), electronic waste, jewelry, automotive components, building components, tools, musical instruments, medical equipment, industrial machinery, soldering or brazing materials, soldered or brazed components, coins, solar panels, catalysts, mirror components, glass components, multilayer ceramic chip capacitor (MLCC), spent silver oxide batteries, or a combination thereof.
67. The method of any one of items 60 to 66, wherein the substance comprising coinage metal comprises ores, coinage metal-concentrates, mining concentrates, or electronic waste.
68. The method of item 67, wherein the electronic waste comprises electronic equipment or components thereof.
69. The method of any one of items 66 to 68, wherein the electronic waste comprises motherboards, chip resistors, chip semiconductors, printed circuit boards, integrated circuit chips, or a combination thereof.
70. The method of any one of items 60 to 69, wherein the substance comprising coinage metal is a substance comprising copper and/or silver.
71. The method of any one of items 60 to 70, further comprising: separating the leach solution containing the leached coinage metal from insoluble impurities; treating the leached coinage metal in the leach solution under conditions to obtain the coinage metal; and separating the coinage metal from the leach solution.
72. The method of item 71, wherein treating the leached coinage metal in the leach solution under conditions to obtain the coinage metal comprises reduction, electrowinning, ion exchange, metal-salt precipitation, or a combination thereof.
73. The method of item 71 or 72, wherein treating the leached coinage metal in the leach solution under conditions to obtain the coinage metal comprises electrowinning.
74. The method of any one of items 60 to 73, wherein the leached coinage metal is copper.
75. The method of any one of items 60 to 74, wherein the leached coinage metal is silver.
76. The method of any one of items 60 to 75, wherein the leached coinage metal is copper and silver.
77. The method of any one of items 1 to 76, wherein the leaching yield of the coinage metal is >65%, >70%, or >75%, or >80%, or >85%, or >90%, or >95%, or >98%, or >99%; preferably >80%, or >85%, >90%, or >95%, or >98%, or >99%.
78. The method of any one of items 1 to 77, wherein the method has leaching yield (Y₁) the coinage metal, an incumbent leaching process has leaching yield (Y₂) of the coinage metal, and the difference in leaching yield (Y₁−Y₂) is about 10% to about 90%, or about 12% to about 90%, or about 15% to about 90%, or about 20% to about 90%, or about 30% to about 90%, or about 40% to about 90%, or about 45% to about 90%, or about 50% to about 90%.
79. The method of any one of items 1 to 78, wherein the method has leaching yield (Y₁) of the coinage metal, an incumbent leaching process has leaching yield (Y₂) of the coinage metal, and the percent increase in leaching yield [(Y₁−Y₂)/|Y₂|]×100) is about 10% to about 1500%, or about 20% to about 1200%, or about 20% to about 1100%, or about 20% to about 1000%, or about 20% to about 900%, or about 20% to about 800%, or about 20% to about 700%, or about 20% to about 600%, or about 20% to about 500%, or about 20% to about 400%, or about 20% to about 300%, or about 20% to about 250%, or about 20% to about 200%, or about 20% to about 100%, or about 20% to about 70%, or about 20% to about 60%, or about 20% to about 50%, or about 20% to about 40%, or about 20% to about 30%.
80. An aqueous leach solution for use in leaching coinage metal from a substance comprising coinage metal, the solution comprising: (a) a leaching acid; (b) an oxidizing agent; and (c) a water-miscible stabilizer.
81. The solution of item 81, wherein each of the leaching acid, oxidizing agent, and water-miscible stabilizer is a different chemical compound.
82. The solution of item 80 or 81, wherein the stabilizer is a water-miscible carboxylic acid having a first pKₐ≥3.
83. The solution of any one of items 80 to 82, wherein the stabilizer is a water-miscible monocarboxylic acid, water-miscible polycarboxylic acid, carboxylates thereof, or a combination thereof.
84. The solution of item 80 or 83, wherein the stabilizer is a water-miscible C₂-C₅ monocarboxylic acid, carboxylates thereof, or a combination thereof.
85. The solution of item 84, wherein the water-miscible monocarboxylic acid is acetic acid, carboxylates thereof, or a combination thereof.
86. The solution of any one of items 80 to 85, wherein the stabilizer is a water-miscible C₂-C₈ polycarboxylic acid, carboxylates thereof, or a combination thereof.
87. The solution of item 86, wherein the water-miscible polycarboxylic acid is citric acid, carboxylates thereof, or a combination thereof.
88. The solution of any one of items 80 to 88 wherein the stabilizer is <50% (vol/vol), or ≥20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the leach solution.
89. The solution of any one of items 80 to 88, wherein the leaching acid is an acid having a first pKₐ≤1, or <0.
90. The solution of any one of items 80 to 89, wherein the leaching acid is H₂SO₄, HNO₃, or a combination thereof.
91. The solution of any one of items 80 to 90, wherein the leaching acid is H₂SO₄.
92. The solution of item 91, wherein the H₂SO₄ is at a concentration of about 0.01M to about 5M, or about 0.01M to about 2M, or about 0.01M to about 1M, or about 0.01M to about 0.5M.
93. The solution of any one of items 80 to 90, wherein the leaching acid is HNO₃ at a concentration of <2M, or about 1M to about 2M, or <1M.
94. The solution of any one of items 80 to 93, wherein the leaching acid is not HNO₃.
95. The solution of any one of items 80 to 94, wherein the oxidizing agent has a standard reduction potential of ≥0.6V, ≥0.65V or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or 96. The solution of any one of items 80 to 92, wherein the oxidizing agent is CuCl₂, FeCl₃, MnO₂, KMnO₄, H₂O₂, Fe₂(SO₄)₃, or a combination thereof.
97. The solution of any one of items 80 to 96, wherein the oxidizing agent is H₂O₂ or Fe₂(SO₄)₃, or a combination thereof.
98. The solution of any one of items 80 to 97, wherein the oxidizing agent is H₂O₂.
99. The solution of item 98, wherein the H₂O₂ is about is about 1% to about 20% (vol/vol), or about 5% to about 15% (vol/vol), or about 10% to about 15% (vol/vol), or about 15% (vol/vol) of the leach solution.
100. The solution of any one of items 80 to 97, wherein the oxidizing agent is Fe₂(SO₄)₃.
101. The solution of item 100, wherein the Fe₂(SO₄)₃ is about 0.1% to about 5% (vol/vol), or about 0.1% to about 1% (vol/vol), or about 0.1% to about 0.5% (vol/vol), or about 0.3% (vol/vol) of the leach solution.
102. The solution of any one of items 80 to 101, wherein the substance is a ground substance comprising particles having a size of 250 microns.
103. The solution of any one of items 80 to 102, wherein the substance comprising coinage metal comprises ores, coinage metal-concentrates, mining concentrates (e.g., Cu and/or Ag mining concentrates), electronic waste, jewelry, automotive components, building components, tools, musical instruments, medical equipment, industrial machinery, soldering or brazing materials, soldered or brazed components, coins, solar panels, catalysts, mirror components, glass components, multilayer ceramic chip capacitor (MLCC), spent silver oxide batteries, or a combination thereof.
104. The solution of any one of items 80 to 103, wherein the substance comprising coinage metal comprises ores, coinage metal-concentrates, mining concentrates, or electronic waste.
105. The solution of item 104, wherein the electronic waste comprises electronic equipment or components thereof.
106. The solution of item 104 or 105, wherein the electronic waste comprises motherboards, chip resistors, chip semiconductors, printed circuit boards, integrated circuit chips, or a combination thereof.
107. The solution of any one of items 80 to 106, wherein the substance comprising coinage metal is a substance comprising copper and/or silver.
108. The solution of item 107, wherein the substance comprising copper and/or silver further comprises gold, palladium, rhodium, and/or platinum, and the solution is used for selectively dissolving the copper and/or silver from the substance.
109. The solution of any one of items 80 to 108, wherein the substance comprising copper and/or silver further comprises base metals and/or ferrous metals, and the solution is used for leaching the base metals and/or ferrous metals from the substance comprising coinage metal.
110. The solution of any one of items 80 to 109, wherein the leached coinage metal is copper.
111. The solution of any one of items 80 to 110, wherein the leached coinage metal is silver.
112. The solution of any one of items 80 to 111, wherein the leached coinage metal is copper and silver.
113. A method of leaching coinage metal from a substance comprising coinage metal, the method comprising: (i) contacting the substance with a first aqueous leach solution comprising: (a) a first leaching acid; (b) a first oxidizing agent; and (c) a first water-miscible stabilizer, under conditions to leach a first coinage metal from the substance; and (ii) contacting the substance with a second aqueous leach solution comprising: (a) a second leaching acid; (b) a second oxidizing agent; and (c) a second water-miscible stabilizer, under conditions to leach a second coinage metal from the substance.
114. The method of item 113, wherein each of the first leaching acid, first oxidizing agent, and first water-miscible stabilizer is a different chemical compound; and/or wherein each of the second leaching acid, second oxidizing agent, and second water-miscible stabilizer is a different chemical compound.
115. The method of item 113 or 114, wherein the first stabilizer and/or the second stabilizer is a water-miscible carboxylic acid having a first pKₐ≥3.
116. The method of any one items 113 to 115, wherein the first stabilizer and/or the second stabilizer is a water-miscible monocarboxylic acid, water-miscible polycarboxylic acid, carboxylates thereof, or a combination thereof.
117. The method of any one items 113 to 116, wherein the first stabilizer and/or the second stabilizer is a water-miscible C₂-C₅ monocarboxylic acid, carboxylates thereof, or a combination thereof.
118. The method of item 117, wherein the water-miscible monocarboxylic acid is acetic acid, carboxylates thereof, or a combination thereof.
119. The method of any one items 113 to 118, wherein the first stabilizer and/or the second stabilizer is a water-miscible C₂-C₈ polycarboxylic acid, carboxylates thereof, or a combination thereof.
120. The method of item 119, wherein the water-miscible polycarboxylic acid is citric acid, or carboxylates thereof, or a combination thereof.
121. The method of any one of items 113 to 120, wherein the first stabilizer is <50% (vol/vol), or ≥20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the first leach solution; and/or the second stabilizer is <50% (vol/vol), or ≤20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the second leach solution.
122. The method of any one of items 113 to 121, wherein the first leaching acid and/or the second leaching acid is an acid having a first pKₐ≤1, or <0.
123. The method of any one of items 113 to 122, wherein the first leaching acid and/or the second leaching acid is H₂SO₄, HNO₃, or a combination thereof.
124. The method of any one of items 113 to 123, wherein the first leaching acid and/or the second leaching acid is H₂SO₄.
125. The method of item 124, wherein the H₂SO₄ is at a concentration of about 0.01M to about 5M, or about 0.01M to about 2M, or about 0.01M to about 1M, or about 0.01M to about 0.5M.
126. The method of any one of items 113 to 123, wherein the first leaching acid and/or the second leaching acid is HNO₃ at a concentration of <2M, or about 1M to about 2M, or <1M.
127. The method of any one of items 113 to 126, wherein the first leaching acid and/or the second leaching acid is not HNO₃.
128. The method of any one of items 113 to 127, wherein the first oxidizing agent and/or the second oxidizing agent has a standard reduction potential of ≥0.6V, ≥0.65V or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V. 129. The method of any one of items 113 to 128, wherein the first oxidizing agent and/or the second oxidizing agent is CuCl₂, FeCl₃, MnO₂, KMnO₄, H₂O₂, Fe₂(SO₄)₃, or a combination thereof.
130. The method of any one of items 113 to 129, wherein the first oxidizing agent and/or the second oxidizing agent is H₂O₂ or Fe₂(SO₄)₃.
131. The method of any one of items 113 to 130, wherein the first oxidizing agent and/or the second oxidizing agent is H₂O₂.
132. The method of item 131, wherein the H₂O₂ is about 1% to about 15% (vol/vol), or about 5% to about 15% (vol/vol), or about 10% to about 15% (vol/vol), or about 15% (vol/vol) of the first leach solution and/or the second leach solution.
133. The method of any one of items 113 to 130, wherein the first oxidizing agent and/or the second oxidizing agent is Fe₂(SO₄)₃.
134. The method of item 133, wherein the Fe₂(SO₄)₃ is about 0.1% to about 5% (vol/vol), or about 0.1% to about 1% (vol/vol), or about 0.1% to about 0.5% (vol/vol), or about 0.3% (vol/vol) of the first leach solution and/or the second leach solution.
135. The method of any one of items 113 to 134, wherein the method further comprises separating the first aqueous leach solution containing the first leached coinage metal from the substance before contacting the substance with the second aqueous leach solution.
136. The method of any one of items 113 to 135, wherein the method further comprises: separating the first leach solution containing the first leached coinage metal from the substance; treating the first leached coinage metal in the first leach solution under conditions to obtain the first coinage metal; and separating the first coinage metal from the leach solution.
137. The method of any one of items 113 to 136, wherein the method further comprises: separating the second leach solution containing the second leached coinage metal from the substance; treating the second leached coinage metal in the second leach solution under conditions to obtain the second coinage metal; and separating the second coinage metal from the leach solution.
138. The method of item 136 or 137, wherein the conditions for treating the first leached coinage metal and/or the second leached coinage metal comprise reduction, electrowinning, ion exchange, metal-salt precipitation, or a combination thereof.
139. The method of item 138, wherein the conditions for treating comprise electrowinning.
140. The method of any one of items 113 to 139, wherein the conditions to leach the first coinage metal from the substance comprises contacting the substance and the first aqueous leach solution at ambient temperature and/or pressure.
141. The method of any one of items 113 to 140, wherein the conditions to leach the first coinage metal from the substance comprises contacting the substance and the first aqueous leach solution at a temperature between about 20° C. to <80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.
142. The method of any one of items 113 to 141, wherein the conditions to leach the first coinage metal from the substance comprises contacting the substance and the first aqueous leach solution at a solid to liquid ratio of about 1:4, or about 1:5, or about 1:6, or about or about 1:7, or about 1:8, or about 1:9, or about 1:10.
143. The method of any one of items 113 to 142, wherein the conditions to leach the first coinage metal from the substance comprises contacting the substance and the first aqueous leach solution for a time of about 0.5 hours to about 6 hours, or about 1 hour to about 6 hours, or about 1 hour or about 3 hours, or about 1 hour to about 2 hours.
144. The method of any one of items 113 to 143, wherein the conditions to leach the second coinage metal from the substance comprises contacting the substance and the second aqueous leach solution at ambient temperature and/or pressure.
145. The method of any one of items 113 to 144, wherein the conditions to leach the second coinage metal from the substance comprises contacting the substance and the second aqueous leach solution at a temperature between about 20° C. to <80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.
146. The method of any one of items 113 to 145, wherein the conditions to leach the second coinage metal from the substance comprises contacting the substance and the second aqueous leach solution at a solid to liquid ratio of about 1:4, or about 1:5, or about 1:6, or about or about 1:7, or about 1:8, or about 1:9, or about 1:10.
147. The method of any one of items 113 to 146, wherein the conditions to leach the second coinage metal from the substance comprises contacting the substance and the second aqueous leach solution for a time of about 0.5 hours to about 6 hours, or about 1 hour to about 6 hours, or about 1 hour or about 3 hours, or about 1 hour to about 2 hours.
148. The method of any one of items 113 to 147, wherein the first coinage metal has standard reduction potential (E⁰_{CM1}), the second coinage metal has standard reduction potential E⁰_{CM2}, and E⁰_{CM2}>E⁰_{CM1}.
149. The method of any one of items 113 to 148, further comprising grinding the substance into particles having a size of ≤250 microns.
150. The method of any one of items 113 to 149, wherein the substance comprising coinage metal comprises ores, coinage metal-concentrates, mining concentrates (e.g., Cu and/or Ag mining concentrates), electronic waste, jewelry, automotive components, building components, tools, musical instruments, medical equipment, industrial machinery, soldering or brazing materials, soldered or brazed components, coins, solar panels, catalysts, mirror components, glass components, multilayer ceramic chip capacitor (MLCC), spent silver oxide batteries, or a combination thereof.
151. The method of any one of items 113 to 150, wherein the substance comprising coinage metal comprises ores, coinage metal-concentrates, mining concentrates, or electronic waste.
152. The method of item 150 or 151, wherein the electronic waste comprises electronic equipment or components thereof.
153. The method of any one of item 150 to 152, wherein the electronic waste comprises motherboards, chip resistors, chip semiconductors, printed circuit boards, integrated circuit chips, or a combination thereof.
154. The method of any one of items 113 to 153, wherein the substance comprising coinage metal is a substance comprising copper and silver.
155. The method of item 154, wherein the substance comprising copper and silver further comprises gold, palladium, rhodium, and/or platinum, and the method selectively dissolves the copper and silver from the substance.
156. The method of any one of items 113 to 155, further comprising leaching base metals and/or ferrous metals from the substance comprising coinage metal.
157. The method of any one of items 113 to 156, wherein the first leached coinage metal is copper.
158. The method of any one of items 113 to 157, wherein the second leached coinage metal is silver.
159. The method of any one of items 113 to 158, further comprising regenerating the first oxidizing agent and/or second oxidizing agent.
160. The method of any one of items 113 to 159, wherein the first oxidizing agent and/or second oxidizing agent is regenerated in-situ, optionally for re-use of the first and/or second aqueous leach solution.
161. The method of item 159 or 160, wherein the first oxidizing agent and/or second oxidizing agent is at least partially reduced and regenerating the first oxidizing agent and/or second oxidizing agent comprises contacting the at least partially reduced oxidizing agent with an aqueous oxidizing solution comprising: (a) an oxidant; (b) an acid; and (c) optionally a water-miscible stabilizer; under conditions to oxidize the at least partially reduced oxidizing agent to regenerate the first oxidizing agent and/or second oxidizing agent.
162. The method of item 161, wherein each of the oxidant, acid, and water-miscible stabilizer is a different chemical compound.
163. The method of item 161 or 162, wherein the oxidant has a third standard reduction potential (E^{O}₃), the first oxidizing agent and/or second oxidizing agent has a fourth standard reduction potential (E^{O}₄), and E^{O}₃>E^{O}₄.
164. The method of item 163, wherein oxidant has a standard reduction potential (E^{O}₃)≥0.6V, ≥0.65V, or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V.
165. The method of any one of items 161 to 164, wherein the oxidant comprises FeCl₃, MnO₂, KMnO₄, H₂O₂, Fe₂(SO₄)₃, or any combination thereof
166. The method of item 165, wherein the oxidant is MnO₂, KMnO₄, H₂O₂, or a combination thereof.
167. The method of item 166, wherein the oxidant is H₂O₂.
168. The method of any one of items 161 to 167, wherein the acid is an acid having at least one pKₐ≤1, or <0.
169. The method of item 168, wherein the acid is H₂SO₄, HNO₃, or a combination thereof.
170. The method of item 169, wherein the acid is H₂SO₄.
171. The method of any one of items 161 to 170, wherein the stabilizer is a water-miscible carboxylic acid having a first pKₐ≥3.
172. The method of item 171, wherein the stabilizer is a water-miscible monocarboxylic acid, water-miscible polycarboxylic acid, carboxylates thereof, or a combination thereof.
173. The method of item 171 or 172, wherein the stabilizer is a water-miscible C₂-C₅ monocarboxylic acid, carboxylates thereof, or a combination thereof; wherein preferably the water-miscible monocarboxylic acid is acetic acid, carboxylates thereof, or a combination thereof.
174. The method of any one of items 171 to 173, wherein the stabilizer is a water-miscible C₂-C₈ polycarboxylic acid, carboxylates thereof, or a combination thereof; wherein preferably the water-miscible polycarboxylic acid is citric acid, carboxylates thereof, or a combination thereof.
175. The method of any one of items 161 to 174, wherein the conditions comprise contacting the at least partially reduced oxidizing agent with the aqueous oxidizing solution at ambient temperature and pressure.
176. The method of any one of items 161 to 175, wherein the conditions comprise contacting the at least partially reduced oxidizing agent with the aqueous oxidizing solution at a temperature between about 20° C. to about 80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.
177. The method of any one of items 161 to 176, wherein the conditions to oxidize the at least partially reduced oxidizing agent to regenerate the first oxidizing agent and/or second oxidizing agent comprise contacting the at least partially reduced oxidizing agent with the aqueous oxidizing solution for a time of about 1 min to about 1 hour, or about 5 min to about 45 min, or about 10 min to about 30 min.
178. The method of any one of items 113 to 177, wherein the leaching yield of the first coinage metal and/or the second coinage metal is >65%, >70%, or >75%, or >80%, or >85%, or >90%, or >95%, or >98%, or >99%; preferably >80%, or >85%, >90%, or >95%, or >98%, or >99%.
179. The method of any one of items 113 to 178, wherein the method has leaching yield (Y₁) of the first coinage metal and/or the second coinage metal, an incumbent leaching process has leaching yield (Y₂) of the first coinage metal and/or the second coinage metal, and the difference in leaching yield (Y₁−Y₂) is about 10% to about 90%, or about 12% to about 90%, or about 15% to about 90%, or about 20% to about 90%, or about 30% to about 90%, or about 40% to about 90%, or about 45% to about 90%, or about 50% to about 90%.
180. The method of any one of items 113 to 179, wherein the method has leaching yield (Y₁) of the first coinage metal and/or the second coinage metal, an incumbent leaching process has leaching yield (Y₂) of the first coinage metal and/or the second coinage metal, and the percent increase in leaching yield [(Y₁−Y₂)/|Y₂|]×100) is about 10% to about 1500%, or about 20% to about 1200%, or about 20% to about 1100%, or about 20% to about 1000%, or about 20% to about 900%, or about 20% to about 800%, or about 20% to about 700%, or about 20% to about 600%, or about 20% to about 500%, or about 20% to about 400%, or about 20% to about 300%, or about 20% to about 250%, or about 20% to about 200%, or about 20% to about 100%, or about 20% to about 70%, or about 20% to about 60%, or about 20% to about 50%, or about 20% to about 40%, or about 20% to about 30%.

### DETAILED DESCRIPTION

Unless otherwise indicated, the definitions and embodiments described in this and other sections are intended to be applicable to all embodiments and aspects of the present disclosure herein described for which they are suitable as would be understood by a person skilled in the art.

### Definitions

As used herein, the term “comprising” and its derivatives are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The term “and/or” as used herein means that the listed items are present, or used, individually or in combination. In effect, this term means that “at least one of” or “one or more” of the listed items is used or present.

As used in this disclosure, the singular forms “a”, “an” and “the” include plural references unless the content clearly dictates otherwise. For example, an embodiment including “a compound” should be understood to present certain aspects with one compound or two or more additional compounds.

The term “suitable” as used herein means that the selection of specific reagents or conditions will depend on the reaction being performed and the desired results, but none-the-less, can generally be made by a person skilled in the art once all relevant information is known.

The term “miscible” as used herein when referring to two liquid phases means that the two liquid phases can, for example be mixed in all proportions to form a homogeneous solution. Two miscible liquid phases will not, for example separate into two liquid phases after mixing. For example, a “water-miscible” liquid such as a “water-miscible organic solvent” is a liquid that can be mixed with water to form a homogeneous solution.

As used herein, the term “ambient temperature” refers to the temperature of the surrounding air or environment in contact with an object. Used herein, the term “ambient pressure” refers to the pressure of the surrounding air or environment in contact with an object. By way of non-limiting example, said object may include a device, a reactor, a reaction, a reaction mixture, a process, a solution, a mixture, or a component thereof. The term “ambient temperature” is generally considered synonymous with the term “room temperature” when indoors. Further, the terms “ambient temperature” and “ambient pressure”, in the context of chemical reactions, are generally understood to mean conducting the reaction without pressurizing or applying heat to the reaction.

The term “coinage metal” of “coinage metals” as used herein refers to a subset of the non-radioactive metals of group 11 of the periodic table of elements, such as copper (Cu), and silver (Ag).

The term “base metal” or “base metals” as used herein refers to any nonferrous metals that are neither precious metals nor noble metals; for example: lead, nickel, tin, aluminum, and zinc.

The term “ferrous metal” or “ferrous metals” as used herein refers to metals and alloys comprising iron; for example: steel, alloy steel, carbon steel, cast iron, and wrought iron.

The term “precious metal” or “precious metals” as used herein refers to gold and/or platinum group metals, such as platinum (Pt), palladium (Pd), rhodium (Rh), ruthenium (Ru), iridium (Ir) and osmium (Os). In some embodiments, “precious metal” refers to gold, palladium, rhodium, and/or platinum. In other embodiments, “precious metal” refers to rhodium, palladium, and/or platinum.

As used herein, the term “first pKₐ” refers to either (i) the pKₐ of the dissociation of a first proton from a polyprotic acid (e.g., able to donate more than one proton); or (ii) the pKₐ of the dissociation of the only proton from a monoprotic acid (e.g., able to donate one proton); as measured in water or aqueous solution.

Herein, the terms “aqueous leach solution” and “leach solution” are used interchangeably.

Herein the terms “electrical waste”, “E-waste”, “electrical scrap”, or “electronic waste” are used interchangeably, and generally refer to electrical or electronic equipment, examples of which include—but are not limited to—integrated circuit chips, printed circuit boards (PCBs), solder in PCBs, glass panels and gaskets in computer monitors, chip resistors and semiconductors, relays and switches, corrosion protection for untreated galvanized steel plates, decorator or hardener for steel housing, cabling and computer housing, plastic housing of electronic equipment and circuit boards, front panel of cathode ray tubes, motherboards, large/small household appliances, IT and telecommunications equipment, electrical and electronic tools, medical devices, lighting equipment, computer monitors, TVs, CPU/hard disk of computers, cables and wires, capacitors, condensers, multilayer ceramic chip capacitor (MLCC), spent silver oxide batteries, or any combination thereof. Such wastes can contain metals such as copper (Cu), silver (Ag), gallium (Ga), tantalum (Ta), tellurium (Te), germanium (Ge), and selenium (Se), which can make them viable for recycling. In some embodiments, the “electrical waste”, or “E-waste”, or “electronic waste” may have been discarded, unwanted, inoperable, and/or nearing or at the end of their “useful life.”

Used herein, “building components” refers to components used to build or furnish a building, including but not limited to wiring, pipes, plumbing components, railings, sinks, tabletops, knobs, handles, kitchen wares, mirror components, windows, glass components, or a combination thereof.

Methods and Solutions for Leaching of Coinage Metals

The present disclosure describes the use of a water-miscible stabilizer in combination with leaching reagents; for example, an aqueous acidified solution containing an oxidizing agent and the stabilizer. Using an aqueous mixture of a leaching acid; an oxidizing agent; and a water-miscible stabilizer to form a leach solution achieved leaching of coinage metals such as copper and/or silver from a substance comprising such metals. In some examples, this leach solution simplifies the recovery process, saves time and energy, and/or produces less waste due to good selectivity for the coinage metals. In some examples, this leach solution permits simultaneous extraction of coinage metals copper and silver.

Accordingly, the present disclosure includes a method of leaching coinage metal from a substance comprising coinage metal, the method comprising, consisting essentially of, or consisting of contacting the substance with an aqueous leach solution comprising, consisting essentially of, or consisting of:
(a) a leaching acid;
(b) an oxidizing agent; and
(c) a water-miscible stabilizer,
   under conditions to leach the coinage metal from the substance.

Additionally, the present disclosure includes a method of leaching coinage metal from a substance comprising coinage metal, the method comprising, consisting essentially of, or consisting of:
(i) contacting the substance with a first aqueous leach solution comprising, consisting essentially of, or consisting of:
   (a) a first leaching acid;
   (b) a first oxidizing agent; and
   (c) a first water-miscible stabilizer,
under conditions to leach a first coinage metal from the substance; and
(ii) contacting the substance with a second aqueous leach solution comprising, consisting essentially of, or consisting of:
   (a) a second leaching acid;
   (b) a second oxidizing agent; and
   (c) a second water-miscible stabilizer,
under conditions to leach a second coinage metal from the substance.

The present disclosure also includes an aqueous leach solution for use in leaching coinage metal from a substance comprising coinage metal, the solution comprising, consisting essentially of, or consisting of:
(a) a leaching acid;
(b) an oxidizing agent; and
(c) a water-miscible stabilizer.

In one or more embodiments of any one of the methods or solution described herein, the leach solution is an aqueous solution. In one or more embodiments, the solvent of the aqueous leach solution comprises, consists essentially of, or consists of water, an aqueous solvent, an aqueous solution, or a combination thereof. In one of more embodiments, the solvent for the leach solution is aqueous or water-based. It is generally accepted by persons skilled in the art that a solvent is defined as a liquid or solution making up ≥50 wt % or vol/vol % of a solution (e.g., makes up at least 50 wt % or vol/vol % of the liquid phase of the solution). In one or more embodiments of any one of the methods or solution described herein, the leaching acid is not the solvent of the aqueous leach solution, as it is present in the leach solution at a vol/vol % that is <50%. In one or more embodiments of any one of the methods or solution described herein, the oxidizing agent is not the solvent of the aqueous leach solution, as it is present in the leach solution at a vol/vol % that is <50%. In one or more embodiments of any one of the methods or solution described herein, the stabilizer is not the solvent of the aqueous leach solution, as it is present in the aqueous leach solution at a vol/vol % that is <50%.

In one or more embodiments of any one of the methods or solution described herein, the aqueous leach solution comprises, consists essentially of, or consists of a leaching acid; an oxidizing agent; and a water-miscible stabilizer. In one or more embodiments, each of the leaching acid, oxidizing agent, and water-miscible stabilizer is a separate, distinct component. In one or more embodiments, each of the leaching acid, oxidizing agent, and water-miscible stabilizer is a different chemical compound relative to the other. In one or more embodiments, the leaching acid cannot also act as the oxidizing agent and/or stabilizer; the oxidizing agent cannot also act as the leaching acid and/or stabilizer; and the stabilizer cannot also act as the leaching acid and/or oxidizing agent.

In one or more embodiments, even if the leaching acid has oxidizing and/or stabilizing properties, a separate, distinct oxidizing agent will be added, and a separate, distinct stabilizer will be added to the aqueous leach solution. In one or more embodiments, if the leaching acid has oxidizing and/or stabilizing properties, a separate, distinct oxidizing agent and stabilizer will be added because the leaching acid may not be present in the aqueous leach solution at a concentration sufficient to act as both a leaching acid, and oxidizing agent and/or stabilizer. In one or more embodiments, if the leaching acid has oxidizing and/or stabilizing properties, a separate, distinct oxidizing agent and stabilizer will be added because it may improve or increase the leaching yield, relative to the leaching yield when separate, distinct oxidizing agents and stabilizers are not added.

In one or more embodiments, even if the oxidizing agent has acidic and/or stabilizing properties, a separate, distinct leaching acid will be added, and a separate, distinct stabilizer will be added to the aqueous leach solution. In one or more embodiments, if the oxidizing agent has acidic and/or stabilizing properties, a separate, distinct leaching acid and stabilizer will be added because the oxidizing agent may not be present in the aqueous leach solution at a concentration sufficient to act as both oxidizing agent, and a leaching acid and/or stabilizer. In one or more embodiments, if the oxidizing agent has acidic and/or stabilizing properties, a separate, distinct leaching acid and stabilizer will be added because it may improve or increase the leaching yield, relative to the leaching yield when separate, distinct leaching acids and stabilizers are not added.

In one or more embodiments, even if the stabilizer has acidic and/or oxidizing properties, a separate, distinct leaching acid will be added, and a separate, distinct oxidizing agent will be added to the aqueous leach solution. In one or more embodiments, even if the stabilizer has acidic and/or oxidizing properties, a separate, distinct leaching acid and oxidizing agent will be added because the stabilizer may not be present in the aqueous leach solution at a concentration sufficient to act as both stabilizer, and a leaching acid and/or oxidizing agent. In one or more embodiments, even if the stabilizer has acidic, a separate, distinct leaching acid will be added because the stabilizer may not be acidic enough (e.g., have a low enough pKₐ) to act a leaching acid. In one or more embodiments, if the stabilizer has acidic and/or oxidizing properties, a separate, a separate, distinct leaching acid and oxidizing agent will be added because it may improve or increase the leaching yield, relative to the leaching yield when separate, distinct leaching acids and oxidizing agents are not added.

Leaching Conditions

In one or more embodiments of any one of the methods or solution of the present disclosure, the conditions to leach coinage metal from the substance comprising coinage metal comprises contacting the substance and the aqueous leach solution at ambient temperatures for a time of about 30 min, or about 60 min, or about 120 min, or about 180 min, or about 240 min, or about 300 min, or about 360; or for a time between about 30 min to about 60 min, or about 30 min to about 120 min, or about 30 min to about 180 min, or about 30 min to about 240 min, or about 30 min to about 300 min, or about 30 min to about 360 min; or for any time between about 30 min to about 360 min; or for any range of time between about 30 min to about 360 min.

In one or more embodiments of any one of the methods or solution of the present disclosure, the conditions to leach coinage metal from the substance comprising coinage metal comprises contacting the substance and the aqueous leach solution at ambient temperatures and pressures for a time of about 30 min, or about 60 min, or about 120 min, or about 180 min, or about 240 min, or about 300 min, or about 360; or for a time between about 30 min to about 60 min, or about 30 min to about 120 min, or about 30 min to about 180 min, or about 30 min to about 240 min, or about 30 min to about 300 min, or about 30 min to about 360 min; or for any time between about 30 min to about 360 min; or for any range of time between about 30 min to about 360 min.

In one or more embodiments of any one of the methods or solution of the present disclosure, the conditions to leach coinage metal from the substance comprising coinage metal comprises contacting the substance and the aqueous leach solution at a temperature of ≥80° C., or ≥70° C., or ≥60° C., or ≥50° C., or ≥40° C., or ≥30° C., or about ≥20° C.; or at a temperature between about 20° C. to about 80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.; or at any temperature between about 16° C. and about 80° C.; for a time of about 30 min, or about 60 min, or about 120 min, or about 180 min, or about 240 min, or about 300 min, or about 360; or for a time between about 30 min to about 60 min, or about 30 min to about 120 min, or about 30 min to about 180 min, or about 30 min to about 240 min, or about 30 min to about 300 min, or about 30 min to about 360 min; or for any time between about 30 min to about 360 min; or for any range of time between about 30 min to about 360 min.

In one or more embodiments of any one of the methods or solution of the present disclosure, the conditions to leach coinage metal from the substance comprising coinage metal comprises contacting the substance and the aqueous leach solution at a solid to liquid ratio of about 1:4, or about 1:5, or about 1:6, or about or about 1:7, or about 1:8, or about 1:9, or about 1:10; or at any ratio between about 1:4 and about 1:10. In some embodiments, a solid to liquid ratio of about 1:3 or less may not include sufficient aqueous leach solution for leaching of coinage metal from a substance comprising coinage metal. In some embodiments, a solid to liquid ratio of more than 1:10 may include too much aqueous leach solution for leaching of coinage metal from a substance comprising coinage metal.

In one or more embodiments of any one of the methods or solution described herein, the leaching conditions comprise stirring the aqueous leach solution. In one or more embodiments, the leaching conditions comprise adding together the leaching acid, the oxidizing agent, and the water-miscible stabilizer in water or aqueous solution any order prior to contacting the substance comprising the coinage metal.

In one or more embodiments of any one of the methods or solution described herein, the leaching conditions do not comprise purifying any one or combination of the leaching acid, the oxidizing agent, and the water-miscible stabilizer. In one or more embodiments, the leaching conditions do not comprise degassing any one or combination of the leaching acid, the oxidizing agent, the water-miscible stabilizer, or the water or aqueous solution.

Leaching Acid

In one or more embodiments of any one of the methods or solution described herein, the leaching acid in the aqueous leach solution is an acid having a first pKₐ≤1, or an acid having a first pKₐ<0, or an acid having a first pKₐ of about −10 to about −1, or an acid having a first pKₐ of about −7 to about −1, or an acid having a first pKₐ of about −3 to about −1, as measured in water or aqueous solution. In one or more embodiments of any one of the methods or solution described herein, the leaching acid in the aqueous leach solution is a monoprotic acid, or a polyprotic acid.

In one or more embodiments of any one of the methods or solution described herein, the leaching acid is a ligand source. In one or more embodiments, the ligand sourced from the leaching acid interacts with, and stabilizes the leached coinage metal. In one or more embodiments, stabilizing the leached coinage metal comprises solubilizing the leached metal in the aqueous leach solution. In one or more embodiments, stabilizing the leached coinage metal comprises forming a complex or salt with the leached coinage metal in the aqueous leach solution. In one or more embodiments, stabilizing the leached coinage metal comprises preventing the leached metal from being reduced back to its metallic form. In one or more embodiments, the leached coinage metal comprises the oxidized form or forms of the leached coinage metal. In one or more embodiments, stabilizing the leached coinage metal comprises maintaining the leached metal in its oxidized form(s). In one or more embodiments, the ligand sourced from the leaching acid comprises the conjugate base of the leaching acid. In one or more embodiments, there may be one conjugate base if the leaching acid is monoprotic; or multiple conjugate bases if the leaching acid is polyprotic. In some embodiments, when there are multiple conjugate bases, at least one conjugate base may be protonated.

In one or more embodiments, the leaching acid has a concentration of from about 0.5M to about 5M, about 1M to about 5M, or from about 1M to about 4M, or from about 1M to about 3M, or from about 1M to about 2M; or at any concentration between about 0.5M and about 5M; or at any range of concentrations between about 0.5M and about 5M.

In one or more embodiments, the leaching acid is H₂SO₄, HNO₃, or a combination thereof. In one or more embodiments, the leaching acid is H₂SO₄. In one or more embodiments wherein the leaching acid is H₂SO₄, the ligand is SO₄³⁻. In one or more embodiments, the H₂SO₄ is at a concentration of about 0.01M to about 5M, or about 0.01M to about 2M, or about 0.01 to about 1 M, or about 0.01 to about 0.5 M, or about 1M to about 2M, or at any concentration between about 0.01M and about 5M; or at any range of concentrations between about 0.01M and about 5M. In another embodiment, the leaching acid is HNO₃. In some embodiments wherein the leaching acid is HNO₃, the ligand is NO₃⁻. In one or more embodiments, when the leaching acid is HNO₃, the HNO₃ is at a concentration that is <2M, or between about 1M to about 2M, or <1M, or between 0.5 M to <1M, or <0.5M. In one or more embodiments, the leaching acid is not HNO₃. In one or more embodiments of any one of the methods or solution described herein, the leaching acid is not a hydrogen halide, such as HF, HCl, HBr, or HI. In one or more embodiments, the leaching acid is not a hydrogen halide, as hydrogen halides can leach precious metals such as gold in the presence of oxidizing agents (e.g., H₂O₂). In one or more embodiments, the leaching acid is not a hydrogen halide, as hydrogen halides can form water-insoluble coinage metal halide salts, such as AgCl₂.

Oxidizing Agent

In one or more embodiments of any one of the methods or solution described herein, the oxidizing agent in the aqueous leach solution is an oxidizing agent having a standard reduction potential (E⁰ in volts) sufficiently large enough to oxidize coinage metals under acidic conditions. In one or more embodiments, the oxidizing agent has an E⁰ of ≥0.3V, or ≥0.4V, or ≥0.5V, or ≥0.6V, ≥0.65V, or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V; or any E⁰ between the value of about 0.3V to about 2V. In one or more embodiments, the oxidizing agent has an E⁰ of ≥0.31V, or ≥0.65V, or ≥0.77V, or ≥1.76V.

In one or more embodiments, the oxidizing agent has an E⁰ of about 1.2V to ≥1.8V. Such an oxidizing agent may be selected for leaching coinage metal when the substance comprising coinage metal further comprises base and/or ferrous metals, and oxidizing said base and/or ferrous metals to their metal oxide forms is desirable, or acceptable for downstream processing (e.g., recovery of precious metals, or platinum group metals). In some embodiments, oxidizing agents having an E⁰ of about 1.2V to about 1.8V comprise, consists essentially of, or consists of H₂O₂, MnO₂, KMnO₄, or a combination thereof.

In one or more embodiments, the oxidizing agent has an E⁰ of about 0.6V to <1.2V. Such oxidizing agents may be selected for leaching coinage metal when the substance comprising coinage metal further comprises base and/or ferrous metals, and oxidizing said base and/or ferrous metals to their metal oxide forms is undesirable, or unacceptable for downstream processing. For example, if the substance comprising coinage metals further comprises not only base and/or ferrous metals, but also precious or platinum group metals, the downstream processing or recovery of the precious or platinum group metals from the substance may be hindered by an excess of base and/or ferrous metal oxides, as these oxides may consume or deplete the acid needed for leaching the precious or platinum group metals. In some embodiments, the oxidizing agent having an E⁰ of about 0.6V to <1.2V comprises, consists essentially of, or consists of Fe₂(SO₄)₃, FeCl₃, or a combination thereof.

In one or more embodiments, the oxidizing agent has an E⁰ of 0.6V. Such oxidizing agents may be selected for leaching coinage metal from a substance comprising coinage metal when the substance comprises Ag, or Ag and Cu, and it is desirable to leach Ag, or both Ag and Cu from the substance. In one or more embodiments, the oxidizing agent having an E⁰ of ≥0.6V comprises, consists essentially of, or consists of FeCl₃, MnO₂, KMnO₄, H₂O₂, Fe₂(SO₄)₃, or any combination thereof. In one or more embodiments, the oxidizing agent has an E⁰ of about 0.3V to <0.6V. Such oxidizing agents may be selected for leaching coinage metal from a substance comprising coinage metal when the substance comprises Cu, or Cu and Ag, and it is desirable to leach only Cu from the substance. In one or more embodiments, the oxidizing agent having an E⁰ of about 0.3V to <0.6V comprises, consists essentially of, or consists of CuCl₂.

In one or more embodiments of any one of the methods or solution described herein, the oxidizing agent also acts as a ligand source. In one or more embodiments, the ligand sourced from the oxidizing agent interacts with, and stabilizes the leached coinage metal. In one or more embodiments, stabilizing the leached coinage metal comprises solubilizing the leached metal in the aqueous leach solution. In one or more embodiments, stabilizing the leached coinage metal comprises forming a complex or salt with the leached coinage metal in the aqueous leach solution. In one or more embodiments, stabilizing the leached coinage metal comprises preventing the leached metal from being reduced back to its metallic form. In one or more embodiments, the leached coinage metal comprises the oxidized form or forms of the leached coinage metal. In one or more embodiments, stabilizing the leached coinage metal comprises maintaining the leached metal in its oxidized form(s). In one or more embodiments, the ligand sourced from the oxidizing agent comprises a counter-ion of the oxidizing agent, or a product of a redox reaction involving the oxidizing agent. In some embodiments, when the oxidizing agent acts as a ligand source, the oxidizing agent comprises, or consists essentially of Fe₂(SO₄)₃ and the ligand is the counter-ion SO₄²⁻. In one or more embodiments of any one of the methods or solution described herein, when the oxidizing agent also acts as a ligand source, lower concentrations or lower amounts of the leaching acid (e.g., <1M, or ≥0.5 M, or <0.1M, or ≤0.05 M, or ≤0.01M) may be used relative to when the oxidizing agent does not act as a ligand source. In one or more embodiments of any one of the methods or solution described herein, when the oxidizing agent also acts as a ligand source, lower concentrations or lower amounts (e.g., <1M, or ≤0.5 M, or ≤0.1M, or ≤0.05 M, or ≤0.01M) of the leaching acid may be used when the leaching acid is a ligand source.

In one or more embodiments of any one of the methods or solution described herein, the oxidizing agent does not produce a halide source, such as a halide gas (e.g., chlorine gas) when used as part of the aqueous leach solution.

In one or more embodiments of any one of the methods or solution described herein, wherein the leached coinage metal is treated under conditions to obtain the coinage metal, the oxidizing agent may be selected based on the conditions for treating the coinage metal. In some embodiments, oxidizing agents comprising iron, such as Fe₂(SO₄)₃ or FeCl₃, may be selected when the conditions for treating the coinage metal comprise, or consist essentially of reduction, ion exchange, metal-salt precipitation, or a combination thereof. In other embodiments, oxidizing agents comprising iron, such as Fe₂(SO₄)₃ or FeCl₃, may not be selected when the conditions for treating the coinage metal comprise, or consist essentially of electrowinning. In some embodiments, higher concentrations of iron (e.g., iron salts) may impact the efficacy of the electrowinning, as iron redox reactions can consume electricity and decrease efficiency of coinage metal recovery.

In one or more embodiments of any one of the methods or solution described herein, the oxidizing agent in the aqueous leach solution is CuCl₂, FeCl₃, MnO₂, KMnO₄, H₂O₂, Fe₂(SO₄)₃, or any combination thereof. In one or more embodiments, the oxidizing agent is any subset of the oxidizing agents selected from the group consisting of CuCl₂, FeCl₃, MnO₂, KMnO₄, H₂O₂, Fe₂(SO₄)₃, and any combination thereof. In one or more embodiments, the oxidizing agent is H₂O₂, Fe₂(SO₄)₃, or a combination thereof. In one or more embodiments, the oxidizing agent is present in the aqueous leach solution at an amount (vol/vol) of about 0.1% to about 15%, or about 0.3% to about 15%, or about 0.5% to about 15%, or 1% to about 15%, or about 1% to about 10%, or 1% to about 5%; or about 0.1% to about 5%, or about 0.1% to about 2.5%, or about 0.1% to about 1%; or about 0.1% to about 0.5%, or about 0.3% to about 0.5%; or at any amount between about 0.1% and about 15%; or at any range of amounts between about 0.1% and about 15%. In one or more embodiments, the oxidizing agent is H₂O₂. In one or more embodiments, the H₂O₂ is present in the aqueous leach solution at an amount (vol/vol) of about 1% to about 20% (vol/vol), or about 5% to about 15% (vol/vol), or about 10% to about 15% (vol/vol), or about 15% (vol/vol); or at any amount between about about 1% and about 20%; or at any range of amounts between about 0.1% and about 20%. In one or more embodiments, the oxidizing agent is Fe₂(SO₄)₃. In one or more embodiments, the Fe₂(SO₄)₃ is present in the aqueous leach solution at an amount (vol/vol) of is about 0.1% to about 5% (vol/vol), or about 0.1% to about 1% (vol/vol), or about 0.1% to about 0.5% (vol/vol), or about 0.3% (vol/vol); or at any amount between about 0.1% and about 5%; or at any range of amounts between about 0.1% and about 5%. In one or more embodiments of any one of the methods or solution described herein, the amount of the oxidizing agent present in the aqueous leach solution may be determined, at least in part, by the volatility and/or exothermic nature of the oxidizing agent when used in the aqueous leach solution. For example, in embodiments where the oxidizing agent is H₂O₂, a higher vol/vol % of oxidizing agent may be used (e.g., about 10-15%) at least to compensate for the exothermic nature of its redox reactions, which can lead to evaporation/decomposition of the H₂O₂ as oxidizing agent. In other embodiments where the oxidizing agent is Fe₂(SO₄)₃, for example, a lower vol/vol % of oxidizing agent may be used (e.g., 0.3-0.5%), at least because: (i) redox reactions involving Fe₂(SO₄)₃ tend to be less exothermic relative to those involving H₂O₂, and as such, there tends to be little to no evaporation/decomposition of Fe₂(SO₄)₃ as an oxidizing agent; and (ii) Fe₂(SO₄)₃ can also act as a ligand source to facilitate stabilizing the leached coinage metal as it is leached. Selection of a suitable amount of oxidizing agent for use in the aqueous leach solution can be made by a person skilled in the art.

Regeneration of Oxidizing Agent

In one or more embodiments of any one of the methods described herein, the oxidizing agent is regenerated. In one or more embodiments, the oxidizing agent is regenerated in-situ. In one or more embodiments, regenerating the oxidizing agent can facilitate reuse or recycling of the aqueous leach solution. In one or more embodiments, reuse or recycling of the aqueous leach solution can facilitate multiple uses of the same aqueous leach solution for leaching coinage metal from a substance or substances comprising coinage metal.

In one or more embodiments of any one of the methods described herein, the oxidizing agent is at least partially reduced when leaching coinage metal from the substance comprising coinage metal. In one or more embodiments, reusing or recycling the same aqueous leach solution involves the at least partially reduced oxidizing agent being oxidized back to a higher oxidation state (e.g., its initial oxidation state). As such, in one or more embodiments of any one of the methods described herein, regenerating the oxidizing agent comprises contacting the at least partially reduced oxidizing agent with an aqueous oxidizing solution comprising, consisting essentially of, or consisting of: (a) an oxidant; (b) an acid; and (c) optionally a water-miscible stabilizer, under conditions to oxidize the at least partially reduced oxidizing agent to regenerate the oxidizing agent.

In one or more embodiments, the oxidant used for regenerating the oxidizing agent has a higher reduction potential than the oxidizing agent. In one or more embodiments, the oxidant has a higher reduction potential than the at least partially reduced oxidizing agent. In one or more embodiments, the oxidant has a first standard reduction potential (E^{O}₁), the oxidizing agent has a second standard reduction potential (E^{O}₂), and E^{O}₁>E^{O}₂. In one or more embodiments, the oxidant has a first standard reduction potential (E^{O}₁), the at least partially reduced oxidizing agent has a second standard reduction potential (E^{O}₂′), and E^{O}₁>E^{O}₂′. In one or more embodiments, the oxidant has a standard reduction potential ≥0.6V, or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V; or any E⁰ between the value of about 0.6V to about 2V. In one or more embodiments, the oxidant comprises, consists essentially of, or consists of FeCl₃, MnO₂, KMnO₄, H₂O₂, Fe₂(SO₄)₃, or any combination thereof. In one or more embodiments, the oxidant comprises, consists essentially of, or consists of FeCl₃, MnO₂, KMnO₄, H₂O₂, or any combination thereof. In one or more embodiments, the oxidant comprises, consists essentially of, or consists of MnO₂, KMnO₄, H₂O₂, or any combination thereof. Selection of a suitable oxidant can be made by a person skilled in the art based on the oxidizing agent to be regenerated. Selection of a suitable amount of oxidant for use in regenerating the oxidizing agent can be made by a person skilled in the art.

In one or more embodiments, the acid used for regenerating the oxidizing agent is an acid having a first pKₐ≤1, or an acid having a first pKₐ<0, or an acid having a first pKₐ of about −10 to about −1, or an acid having a first pKₐ of about −7 to about −1, or an acid having a first pKₐ of about −3 to about −1, as measured in water or aqueous solution. In one or more embodiments the acid is a monoprotic acid, or a polyprotic acid. In one or more embodiments, the acid is a ligand source. In one or more embodiments, the ligand sourced from the acid comprises the conjugate base of the acid. In one or more embodiments, the ligand sourced from the acid facilitates regeneration of the oxidizing agent, at least in part, by providing counter-ions. In one or more embodiments, the acid is H₂SO₄, HNO₃, or a combination thereof.

In one or more embodiments, regenerating the oxidizing agent optionally comprises use of a water-miscible stabilizer. In one or more embodiments, regenerating the oxidizing agent comprises use of a water-miscible stabilizer. In one or more embodiments, the water-miscible stabilizer used for regenerating the oxidizing agent comprises, consists essentially of, or consists of any one or more of the water-miscible stabilizers as described herein (e.g., see section entitled, “Water-miscible Stabilizer”).

In one or more embodiments, the conditions to oxidize the at least partially reduced oxidizing agent to regenerate the oxidizing agent comprise contacting the at least partially reduced oxidizing agent with the aqueous oxidizing solution for a time of about 1 min to about 1 hour, or about 5 min to about 45 min, or about 10 min to about 30 min. In one or more embodiments, the conditions comprises contacting the at least partially reduced oxidizing agent with the aqueous oxidizing solution at a temperature of ≥80° C., or ≥70° C., or ≥60° C., or ≥50° C., or ≥40° C., or ≥30° C., or about ≥20° C.; or at a temperature between about 20° C. to about 80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.; or at any temperature between about 16° C. and about 80° C. In one or more embodiments, the conditions comprises contacting the at least partially reduced oxidizing agent with the aqueous oxidizing solution at ambient temperatures and pressures.

Water-Miscible Stabilizer

In one or more embodiments of any one of the methods or solution described herein, the water-miscible stabilizer in the aqueous leach solution stabilizes the leached coinage metal. In one or more embodiments, stabilizing the leached coinage metal comprises preventing the leached metal from being reduced back to its metallic form. In one or more embodiments, the leached coinage metal comprises the oxidized form or forms of the leached coinage metal. In one or more embodiments, stabilizing the leached coinage metal comprises maintaining the leached metal in its oxidized form(s). In one or more embodiments, stabilizing the leached coinage metal comprises forming a water-soluble complex with the leached coinage metal. In one or more embodiments, stabilizing the leached coinage metal comprises forming a water-soluble complex with the leached metal in its oxidized form(s).

In one or more embodiments, the water-miscible stabilizer can reduce, inhibit, or prevent formation of foams when leaching substances comprising coinage metal. In one or more embodiments, the water-miscible stabilizer can also facilitate dispersion of powderized substances comprising coinage metal in the aqueous leach solution. In one or more embodiments, facilitating dispersion of a powderized substance facilitates the formation of a relatively homogenous slurry. The formation of a more homogeneous slurry can result in an increase in the surface area of the powderized substance that is in contact with the aqueous leach solution, which can increase leaching rates and decrease leaching times.

In one or more embodiments of any one of the methods or solution described herein, the water-miscible stabilizer comprises, consists essentially of, or consists of a carboxylic acid, a carboxylate, or a combination thereof. In one or more embodiments of any one of the methods or solution described herein, the water-miscible stabilizer comprises, consists essentially of, or consists of a carboxylic acid. In one or more embodiments, the water-miscible stabilizer comprises, consists essentially of, or consists of a carboxylate. In one or more embodiments, when the water-miscible stabilizer comprises a carboxylate, the carboxylate may react with the leaching acid to form a carboxylic acid stabilizer in-situ. In one or more embodiments of any one of the methods or solution described herein, when the water-miscible stabilizer comprises, consists essentially of, or consists of a carboxylic acid and/or a carboxylate that forms a carboxylic acid in-situ, the water-miscible stabilizer has a first pKₐ≥3 and does not and/or cannot act as the leaching acid of the aqueous leach mixture. As described above, the leaching acid in the aqueous leach solution is an acid having a first pKₐ≤1, or an acid having a first pKₐ<0. In contrast, the pKₐ of a carboxylic acid is not 1, or <0, but is generally ≥3, or between about 3 and about 7, or about 4 and about 5. Thus, in one or more embodiments where the water-miscible stabilizer comprises, consists essentially of, or consists a carboxylic acid and/or a carboxylate that forms a carboxylic acid stabilizer in-situ, the water-miscible stabilizer does not and/or cannot act as the leaching acid, as it is not a strong enough acid.

In one or more embodiments of any one of the methods or solution described herein, the water-miscible stabilizer comprises, consists essentially of, or consists of a water-miscible monocarboxylic acid, a water-miscible monocarboxylate, a water-miscible polycarboxylic acid, a water-miscible polycarboxylate, or a combination thereof. In one or more embodiments, the water-miscible stabilizer comprises, consists essentially of, or consists of a water-miscible monocarboxylic acid, a water-miscible monocarboxylate, or a combination thereof. In one or more embodiments, the water-miscible stabilizer comprises, consists essentially of, or consists of a water-miscible polycarboxylic acid, a water-miscible polycarboxylate, or a combination thereof. In one or more embodiments, the water-miscible stabilizer comprises, consists essentially of, or consists of a water-miscible monocarboxylic acid, a water-miscible polycarboxylic acid, or a combination thereof. In one or more embodiments, the water-miscible stabilizer comprises, consists essentially of, or consists of a water-miscible monocarboxylate, a water-miscible polycarboxylate, or a combination thereof.

In one or more embodiments of any one of the methods or solution described herein, the water-miscible stabilizer comprises, consists essentially of, or consists of a water-miscible monocarboxylic acid, or carboxylate thereof. In one of more embodiments, the water-miscible monocarboxylic acid comprises, consists essentially of, or consists of a C₂-C₅ monocarboxylic acid, or carboxylates thereof. In one or more embodiments, the water-miscible monocarboxylic acid comprises, consists essentially of, or consists of a C₂ monocarboxylic acid, a C₃ monocarboxylic acid, a C₄ monocarboxylic acid, a C₅ monocarboxylic acid, carboxylates thereof, or any combination thereof. In one or more embodiments, the water-miscible monocarboxylic acid is acetic acid, or carboxylates thereof. In one or more embodiments, the water-miscible monocarboxylic acid, or carboxylates thereof is present in the aqueous leach solution at an amount (vol/vol) of about 1% to about 25%, or about 3% to about 20%, or about 5% to about 20%, or about 10% to about 20%, or about 15% to about 20%; or at any amount between about 1% and about 25%; or at any range of amounts between about 1% and about 25%.

In one or more embodiments of any one of the methods or solution described herein, the water-miscible stabilizer is a water-miscible polycarboxylic acid, or carboxylate thereof. In other words, the stabilizer is a small molecule (e.g., not an oligomer, nor a polymer) that comprises more than one carboxylic acid functional group. In one of more embodiments, the water-miscible polycarboxylic acid is a C₂-C₈ polycarboxylic acid, or carboxylates thereof. In one or more embodiments, the water-miscible polycarboxylic acid is a C₂ polycarboxylic acid, a C₃ polycarboxylic acid, a C₄ polycarboxylic acid, a C₅ polycarboxylic acid, a C₆ polycarboxylic acid, a C₇ polycarboxylic acid, a C₈ polycarboxylic acid, carboxylates thereof, or any combination thereof. In one or more embodiments, the water-miscible polycarboxylic acid is citric acid, or carboxylates thereof. In one or more embodiments, the water-miscible polycarboxylic acid, or carboxylates thereof is present in the aqueous leach solution at an amount (vol/vol) of about 1% to about 5%, or about 2% to about 5%, or about 3% to about 5%, or about 4% to about 5%; or at any amount between about 1% and about 5%; or at any range of amounts between about 1% and about 5%.

In one or more embodiments of any one of the methods or solution described herein, the water-miscible stabilizer facilitates the simultaneous leaching of more than one coinage metal. In one or more embodiments, the water-miscible stabilizer facilitates the simultaneous leaching of Ag and Cu.

Treating Leached Coinage Metal

In one or more embodiments of the methods described herein, the method further comprises, further consists essentially of, or further consists of: separating the leach solution containing the leached coinage metal from insoluble impurities; treating the leached coinage metal in the leach solution under conditions to obtain the coinage metal; and separating the coinage metal from the leach solution.

In one or more embodiments of the methods described herein, the leach solution containing the leached coinage metal and the insoluble impurities are separated by any suitable means, the selection of which can be made by a person skilled in the art. The coinage metal and the leach solution are separated by any suitable means, the selection of which can be made by a person skilled in the art.

In one or more embodiments of the methods described herein, treating the leached coinage metal in the leach solution under conditions to obtain the coinage metal comprises, consists essentially of, or consists of reduction, electrowinning, ion exchange, metal-salt precipitation, or a combination thereof.

In one or more embodiments, treating the leached coinage metal comprises, consists essentially of, or consists of reduction using a reducing agent. The reducing agent can be any suitable reducing agent for reducing coinage metals. In one or more embodiments, when the leached coinage metal is silver, the reducing agent is any one or combination of H₂, NaBH₄, hydrazine hydrochloride, hydroxylamine hydrochloride, ascorbic acid, formic acid, oxalic acid, metallic copper, Fe powder, and Zn powder. In one or more embodiments, when the leached coinage metal is silver, the reducing agent is any subset of the reducing agents selected from the group consisting of H₂, NaBH₄, hydrazine hydrochloride, hydroxylamine hydrochloride, ascorbic acid, formic acid, oxalic acid, metallic copper, Fe powder, and Zn powder, and any combination thereof. In one or more embodiments, when the leached coinage metal is copper, the reducing agent is any one or combination of H₂, NaBH₄, Fe powder, and Zn powder. In one or more embodiments, when the leached coinage metal is copper, the reducing agent is any subset of the reducing agents selected from the group consisting of H₂, NaBH₄, Fe powder, and Zn powder, and any combination thereof.

In one or more embodiments, treating the leached coinage metal comprises, consists essentially of, or consists of electrowinning, using ion exchange resins, metal-salt precipitation, or any combination thereof. In one or more embodiments, metal-salt precipitation involves reacting the leached coinage metal with, e.g., ammonium chloride to form and precipitate a coinage-metal chloride salt. In one or more embodiments, when the leached coinage metal is silver, the metal-salt precipitation involves reacting the leached silver with ammonium chloride to form and precipitate a silver chloride salt. In one or more embodiments, metal-salt precipitation involves reacting the leached coinage metal, such as silver or copper, with, e.g., sodium hydroxide to form and precipitate a coinage-metal hydroxide salt. Selection of a suitable chloride or hydroxide compound, for use in metal-salt precipitation, can be made by a person skilled in the art.

In one or more embodiments of the methods described herein, treating the leached coinage metal in the leach solution under conditions to obtain the coinage metal comprises, consists essentially of, or consists of electrowinning. In one or more embodiments, electrowinning to obtain coinage metal involves maintaining lower concentrations of iron (e.g., iron salts) in the aqueous leach solution. In one or more embodiments, electrowinning to obtain coinage metal comprises maintaining a ratio of leached coinage metal (e.g., copper) to iron (e.g., iron salts) to at least minimize iron-based redox reactions (e.g., ferrous/ferric redox) from unwantedly consuming electricity. In one or more embodiments, if the leached coinage metal (e.g., copper) to iron (e.g., ferric) ratio is less than six, an iron removal step such as precipitation, solvent extraction, or ion exchange may be necessary.

Substance Comprising Coinage Metal

In one or more embodiments of any one of the methods or solution described herein, the substance comprising coinage metal can be any suitable substance comprising coinage metal such as copper and/or silver. In one or more embodiments, the substance comprising coinage metal comprises anode slime, a coinage metal-containing substance such as a coinage metal concentrate, spent catalyst, electronic scrap or e-waste, coinage metal-containing ore, jewelry scrap, or any combination thereof. In one or more embodiments, substance comprising coinage metal comprises ores, coinage metal-concentrates, mining concentrates (e.g., Cu and/or Ag mining concentrates), electronic waste, jewelry, automotive components, building components, tools, musical instruments, medical equipment, industrial machinery, soldering or brazing materials, soldered or brazed components, coins, solar panels, catalysts, mirror components, glass components, or a combination thereof. In one or more embodiments, substance comprising coinage metal comprises coinage metal comprises ores, coinage metal-concentrates, or electronic waste.

In one or more embodiments, the substance comprising coinage metal comprises electronic scrap or e-waste. In one or more embodiments, the substance comprising coinage metal comprises electronic equipment or components thereof. In one or more embodiments, the electronic scrap or e-waste comprises integrated circuit chips, printed circuit boards (PCBs), solder in PCBs, glass panels and gaskets in computer monitors, chip resistors and semiconductors, relays and switches, corrosion protection for untreated galvanized steel plates, decorator or hardener for steel housing, cabling and computer housing, plastic housing of electronic equipment and circuit boards, front panel of cathode ray tubes, motherboards, large/small household appliances, IT and telecommunications equipment, electrical and electronic tools, medical devices, lighting equipment, computer monitors, TVs, CPU/hard disk of computers, cables and wires, capacitors, condensers, multilayer ceramic chip capacitor (MLCC), spent silver oxide batteries, or any combination thereof. In one or more embodiments, the electronic scrap or e-waste comprises, consists essentially of, or consists of motherboards, chip resistors, chip semiconductors, printed circuit boards, integrated circuit chips, or a combination thereof. In one or more embodiments, the electronic scrap or e-waste comprises, consists essentially of, or consists of printed circuit boards, integrated circuit chips, or a combination thereof.

In one or more embodiments of any one of the methods or solution described herein, the substance comprising coinage metal may be pre-processed prior to contacting or use with the aqueous leach solution. In one or more embodiments, the substance comprising coinage metal is ground up and powderized, prior to contacting, to a particle size of <250 microns. In one or more embodiments, the substance comprising coinage metal is ground up and powderized prior to contacting, and the coinage metal being leached is the coinage metal on the surface of, and from within the substance.

Selective Leaching

In one or more embodiments of any one of the methods or solution described herein, the substance comprising coinage metal is a copper and/or silver-containing substance. In one or more embodiments, the copper and/or silver-containing substance further comprises gold, palladium, rhodium, and/or platinum, and the methods or use of the solution selectively dissolves the copper and/or silver from the copper and/or silver-containing substance. As used herein, “selectively dissolves” refers to dissolving, or leaching one metal or metals to the exclusion of another metal or metals. In one or more embodiments, that the methods or use of the solution “selectively dissolves” copper and/or silver from a copper and/or silver-containing substance refers to the methods of use of the solution leaching copper and/or silver to the exclusion of other metals, such as gold, palladium, rhodium, and/or platinum.

In one or more embodiments, the copper and/or silver-containing substance comprises ores, copper and/or silver concentrates, electronic waste, jewelry, automotive components, building components, tools, musical instruments, medical equipment, industrial machinery, soldering or brazing materials, soldered or brazed components, coins, solar panels, catalysts, mirror components, glass components, or a combination thereof. In one or more embodiments, the copper and/or silver-containing substance comprises an ore, or electronic or electrical waste, or a combination thereof. In one or more embodiments, the electronic or electrical waste comprises, consists essentially of, or consists of printed circuit boards, integrated circuit chips, or a combination thereof. In one or more embodiments, any one of the methods or solution described herein exhibits selectivity for leaching copper and/or silver over gold, palladium, rhodium, and/or platinum from electronic or electrical waste, such as an integrated circuit chip or printed circuit boards.

In one or more embodiments of any one of the methods or solution described herein, the substance comprising coinage metal is a copper-containing substance. In one or more embodiments, the copper-containing substance further comprises gold, palladium, rhodium, and/or platinum, or a combination thereof, and the methods or use of the solution selectively dissolves the copper from the copper-containing substance. In one or more embodiments, the copper-containing substance comprises ores, copper concentrates, electronic waste, jewelry, automotive components, building components, tools, musical instruments, medical equipment, industrial machinery, soldering or brazing materials, soldered or brazed components, coins, solar panels, catalysts, mirror components, glass components, or a combination thereof. In one or more embodiments, the copper-containing substance comprises an ore, or electronic or electrical waste. In one or more embodiments, the electronic or electrical waste comprises, consists essentially of, or consists of integrated circuit chips, printed circuit boards, or a combination thereof. In one or more embodiments, any one of the methods or solution described herein exhibits selectivity for leaching copper over gold, palladium, rhodium, and/or platinum from electronic or electrical waste, such as an integrated circuit chip or printed circuit boards.

In one or more embodiments of any one of the methods or solution described herein, the substance comprising coinage metal is a silver-containing substance. In one or more embodiments, the silver-containing substance further comprises gold, palladium, rhodium, and/or platinum, or a combination thereof, and the methods or use of the solution selectively dissolves the silver from the silver-containing substance. In one or more embodiments, the silver-containing substance comprises ores, silver concentrates, electronic waste, jewelry, automotive components, building components, tools, musical instruments, medical equipment, industrial machinery, soldering or brazing materials, soldered or brazed components, coins, solar panels, catalysts, mirror components, glass components, or a combination thereof. In one or more embodiments, the silver-containing substance comprises an ore, or electronic or electrical waste. In one or more embodiments, the electronic or electrical waste comprises, consists essentially of, or consists of integrated circuit chips, printed circuit boards, or a combination thereof. In one or more embodiments, any one of the methods or solution described herein exhibits selectivity for leaching silver over gold, palladium, rhodium, and/or platinum from electronic or electrical waste such as an integrated circuit chip or printed circuit boards.

In one or more embodiments of the method described herein, the method further comprises leaching base metals and/or ferrous metals from the substance comprising coinage metal. In one or more embodiments, base metals are nonferrous metals that are neither precious metals nor noble metals. In one or more embodiments, the base metals comprise, consist essentially of, or consist of lead, nickel, tin, aluminum, and zinc. In one or more embodiments, ferrous metals are metals and alloys comprising iron. In one or more embodiments, the ferrous metals comprise, consist essentially of, or consist of iron, steel, alloy steel, carbon steel, cast iron, and wrought iron.

In one or more embodiments of any one of the methods or solution described herein, the leached metal is copper, silver, or a combination thereof. In one or more embodiments, the leached metal is copper. In one or more embodiments, the leached metal is silver. In one or more embodiments of any one of the methods or solution described herein, the leached metal is copper and/or silver, and base metals and/or ferrous metals.

Leaching Yields

In one or more embodiments of any one of the methods or solution described herein, when leaching coinage metal from a substance comprising coinage metal, the methods or use of the solution may exhibit a high leaching yield for the leached coinage metal or leached coinage metals. In one or more embodiments, the methods or use of the solution may exhibit a leaching yield that is >65%, >70%, or >75%, or >80%, or >85%, or >90%, or >95%, or >98%. In one or more embodiments, the methods or use of the solution may exhibit a leaching yield that is >99%.

In one or more embodiments of any one of the methods or solution described herein, when leaching coinage metal from a substance comprising coinage metal, the methods or use of the solution may exhibit a higher leaching yield relative to leaching yields exhibited by incumbent leaching processes (e.g., processes consisting of H₂SO₄ and H₂O₂) after leaching for a particular amount of time (e.g., 60 min, 90 min, 120 min, 180 min, etc.) in the presence of a particular amount of stabilizer (e.g., about 1% to about 25% (vol/vol)). In one or more embodiments, the methods or use of the solution may exhibit a leaching yield (Y₁) that is higher than a leaching yield for incumbent leaching processes (Y₂), wherein the difference between Y₁ and Y₂ (i.e., Y₁−Y₂) is about 10% to about 70%, or about 12% to about 70%, or about 15% to about 70%, or about 20% to about 70%, or about 30% to about 70%, or about 40% to about 70%, or about 45% to about 70%, or about 50% to about 70%; or any difference between about 10% and about 70%. In one or more embodiments, the methods or use of the solution may exhibit a leaching yield (Y₁) that is higher than a leaching yield for incumbent leaching processes (Y₂), wherein the difference between Y₁ and Y₂ (i.e., Y₁−Y₂) is about 10% to about 90%, or about 12% to about 90%, or about 15% to about 90%, or about 20% to about 90%, or about 30% to about 90%, or about 40% to about 90%, or about 45% to about 90%, or about 50% to about 90%; or any difference between about 10% and about 90%.

In one or more embodiments, the methods or use of the solution may exhibit an increased leaching yield relative to incumbent leaching processes, wherein the percent increase in yield (i.e., [(Y₁−Y₂)/|Y₂|]×100) is about 20% to about 900%, or about 20% to about 800%, or about 20% to about 700%, or about 20% to about 600%, or about 20% to about 500%, or about 20% to about 400%, or about 20% to about 300%, or about 20% to about 250%, or about 20% to about 200%, or about 20% to about 160%, or about 20% to about 150%, or about 20% to about 130%, or about 20% to about 100%, or about 20% to about 70%, or about 20% to about 60%, or about 20% to about 50%, or about 20% to about 40%, or about 20% to about 30%; or any increase between about 20% and about 900%. In one or more embodiments, the methods or use of the solution may exhibit an increased leaching yield relative to incumbent leaching processes, wherein the percent increase in yield (i.e., [(Y₁−Y₂)/|Y₂|]×100) is about 10% to about 1500%, or about 20% to about 1200%, or about 20% to about 1100%, or about 20% to about 1000%, or about 20% to about 900%, or about 20% to about 800%, or about 20% to about 700%, or about 20% to about 600%, or about 20% to about 500%, or about 20% to about 400%, or about 20% to about 300%, or about 20% to about 250%, or about 20% to about 200%, or about 20% to about 160%, or about 20% to about 150%, or about 20% to about 130%, or about 20% to about 100%, or about 20% to about 70%, or about 20% to about 60%, or about 20% to about 50%, or about 20% to about 40%, or about 20% to about 30%; or any increase between about 10% and about 1500%.

In one or more embodiments of any one of the methods or solution described herein, when leaching copper from a substance comprising copper, or from a substance comprising copper and silver, the methods or use of the solution may exhibit a high leaching yield for the leached copper. In one or more embodiments, the methods or use of the solution may exhibit a leaching yield that is >65%, or >70%, or >75%, or >80%, or >85%, or >90%, or >95%. In one or more embodiments, the methods or use of the solution may exhibit a leaching yield that is >99% or is about 99.5% to about 99.8%. In one or more embodiments, the methods or use of the solution may exhibit a leaching yield that is >99%, or is about 99.5% to about 99.8%, when the substance comprising copper is an integrated circuit chip. In one or more embodiments, the methods or use of the solution may exhibit a leaching yield that is >98%, or is about 98.4% when the substance comprising copper, or the substance comprising copper and silver is printed circuit board.

In one or more embodiments of any one of the methods or solution described herein, when leaching copper from a substance comprising copper, or from a substance comprising copper and silver, the methods or use of the solution may exhibit a higher leaching yield relative to leaching yields exhibited by incumbent leaching processes (e.g., processes consisting of H₂SO₄ and H₂O₂) after leaching for a particular amount of time (e.g., 60 min, 90 min, 120 min, 180 min, etc.), in the presence of a particular amount of stabilizer (e.g., about 1% to about 20% (vol/vol)). In one or more embodiments, the methods or use of the solution may exhibit a leaching yield (Y₁) that is higher than a leaching yield of incumbent leaching processes (Y₂), wherein the difference between Y₁ and Y₂ (i.e., Y₁−Y₂) is about 10% to about 12% after about 60 min, or about 15% to about 17% after about 120 min, or about 22% to about 24% after about 180. In one or more embodiments, the methods or use of the solution may exhibit a leaching yield (Y₁) that is higher than a leaching yield of incumbent leaching processes (Y₂), wherein the difference between Y₁ and Y₂ (i.e., Y₁−Y₂) is about 30% to about 50% after about 60 min, or about 30% to about 45% after about 60 min, about 44% to about 46% after about 60 min, or about 30% to about 32% after about 60 min. In one or more embodiments, the methods or use of the solution may exhibit a leaching yield (Y₁) that is higher than a leaching yield of incumbent leaching processes (Y₂), wherein the difference between Y₁ and Y₂ (i.e., Y₁−Y₂) is about 30% to about 32%, or about 44% to about 46% after about 60 min, when the substance comprising copper is an integrated circuit chip. In one or more embodiments, the methods or use of the solution may exhibit a leaching yield (Y₁) that is higher than a leaching yield of incumbent leaching processes (Y₂), wherein the difference between Y₁ and Y₂ (i.e., Y₁−Y₂) is about 18% to about 20% after about 90 min, when the substance comprising copper or copper and silver is a printed circuit board.

In one or more embodiments, when leaching copper from a substance comprising copper, or from a substance comprising copper and silver, the methods or use of the solution may exhibit an increased leaching yield relative to incumbent leaching processes, wherein the percent increase in yield (i.e., [(Y₁−Y₂)/|Y₂|]×100) is about 20% to about 90%, or about 20% to about 80%, about 20% to about 70%, or about 20% to about 60%, or about 20% to about 50%, or about 20% to about 40%; or any increase between about 20% and about 90%. In one or more embodiments, when leaching copper from a substance comprising copper, or from a substance comprising copper and silver, the methods or use of the solution may exhibit an increased leaching yield relative to incumbent leaching processes, wherein the percent increase in yield (i.e., [(Y₁−Y₂)/|Y₂|]×100) is about 20% to about 90%, or about 20% to about 80%, or about 81%; or about 20% to about 60%, or about 24% to about 55%, when the substance comprising copper is an integrated circuit chip. In one or more embodiments, the methods or use of the solution may exhibit an increased leaching yield relative to incumbent leaching processes, wherein the percent increase in yield (i.e., [(Y₁−Y₂)/|Y₂|]×100) is about 23% to about 25% after about 90 min, when the substance comprising copper or copper and silver is a printed circuit board.

In one or more embodiments of any one of the methods or solution described herein, when leaching silver from a substance comprising silver, or from a substance comprising copper and silver, the methods or use of the solution may exhibit a high leaching yield for the leached silver. In one or more embodiments, the methods or use of the solution may exhibit a leaching yield that is >65%, or >70%, or >75%, or >80%, or >85%, or >90%, or >95%. In one or more embodiments, the methods or use of the solution may exhibit a leaching yield that is >90%, or >97%, or >99%, or is about 90% to about 99.6%, or is about 97% to about 99.6%. In one or more embodiments, the methods or use of the solution may exhibit a leaching yield that is >90%, or >96%, or about 96.3%, or >97%, is about 97.2%, when the substance comprising silver is an integrated circuit chip. In one or more embodiments, the methods or use of the solution may exhibit a leaching yield that is >90%, or is about 91% to about 93% when the substance comprising silver, or the substance comprising copper and silver is printed circuit board.

In one or more embodiments of any one of the methods or solution described herein, when leaching silver from a substance comprising silver, or from a substance comprising copper and silver, the methods or use of the solution may exhibit a higher leaching yield relative to leaching yields exhibited by incumbent leaching processes (e.g., processes consisting of H₂SO₄ and H₂O₂) after leaching for a particular amount of time (e.g., 60 min, 90 min, 120 min, 180 min, etc.), in the presence of a particular amount of stabilizer (e.g., about 1% to about 20% (vol/vol)). In one or more embodiments, the methods or use of the solution may exhibit a leaching yield (Y₁) that is higher than a leaching yield of incumbent leaching processes (Y₂), wherein the difference between Y₁ and Y₂ (i.e., Y₁−Y₂) is about 13% to about 45% after about 60 min, or about 20% to about 52% after about 120 min, or about 15% to about 52% after about 180. In one or more embodiments, the methods or use of the solution may exhibit a leaching yield (Y₁) that is higher than incumbent leaching processes (Y₂), wherein the difference between Y₁ and Y₂ (i.e., Y₁−Y₂) is about 64% to about 69% after about 60 min, or about 64% to about 65% after about 60 min, or about 68% to about 69% after about 60 min; or about 83% to about 89% after about 60 min, or about 83% to about 84% after about 60 min, or about 88% to about 89% after about 60 min. In one or more embodiments, the methods or use of the solution may exhibit a leaching yield (Y₁) that is higher than a leaching yield of incumbent leaching processes (Y₂), wherein the difference between Y₁ and Y₂ (i.e., Y₁−Y₂) is about 64% to about 69% after about 60 min, or about 64% to about 65% after about 60 min, or about 68% to about 69% after about 60 min; or about 83% to about 89% after about 60 min, or about 83% to about 84% after about 60 min, or about 88% to about 89% after about 60 min, when the substance comprising silver or copper and silver is an integrated circuit chip. In one or more embodiments, the methods or use of the solution may exhibit a leaching yield (Y₁) that is higher than a leaching yield of incumbent leaching processes (Y₂), wherein the difference between Y₁ and Y₂ (i.e., Y₁−Y₂) is about 44% to 47% after about 90 min, when the substance comprising silver or copper and silver is a printed circuit board.

In one or more embodiments, when leaching silver from a substance comprising silver, or from a substance comprising copper and silver, the methods or use of the solution may exhibit an increased leaching yield relative to incumbent leaching processes, wherein the percent increase in yield (i.e., [(Y₁−Y₂)/|Y₂|]×100) is about 30% to about 250%, or about 40% to about 250%, or about 50% to about 250%, or about 60% to about 250%, or about 70% to about 250%; or any increase between about 30% and about 250%. In one or more embodiments, when leaching silver from a substance comprising silver, or from a substance comprising copper and silver, the methods or use of the solution may exhibit an increased leaching yield relative to incumbent leaching processes, wherein the percent increase in yield (i.e., [(Y₁−Y₂)/|Y₂|]×100) is about 500% to about 1200%, or about 650% to about 1200%, about 800% to about 1200%; or about 500% to about 600%, about 500% to about 520%; about 600% to about 700%, about 660% to about 680%; or about 800% to about 900%, or about 890% to about 895%; or about 1100% to about 1200%, about 1140% to about 1160%. In one or more embodiments, when leaching silver from a substance comprising silver, the methods or use of the solution may exhibit an increased leaching yield relative to incumbent leaching processes, wherein the percent increase in yield (i.e., [(Y₁−Y₂)/|Y₂|]×100) is about 500% to about 520%; or about 660% to about 680%; or about 890% to about 895%; or about 1140% to about 1160%, when the substance comprising silver is an integrated circuit chip. In one or more embodiments, the methods or use of the solution may exhibit an increased leaching yield relative to incumbent leaching processes, wherein the percent increase in yield (i.e., [(Y₁−Y₂)/|Y₂|]×100) is about 99% to about 101% after about 90 min, when the substance comprising silver or copper and silver is a printed circuit board.

Relative to Incumbent Technologies

Generally, incumbent coinage metal leaching and/or recovery processes include smelting and/or hydrometallurgical processes. In the case of copper and silver recycling from electronic wastes, smelting process is a dominant recycling process on industrial scales. For leaching and/or recovery of copper or silver, hydrometallurgical processes may also be employed. Common lixiviants for the leaching and/or recovery of copper via hydrometallurgical processes include nitric acid or a H₂SO₄/H₂O₂ mixture. The H₂SO₄/H₂O₂ lixiviant mixture tends to be limited to the leaching and recovery of copper, and tends not to be sufficient for the leaching and recovery of copper and silver; thus, when the leaching and/or recovery of copper and silver is desired, H₂SO₄/H₂O₂ lixiviant mixture is generally not used. Sulfuric acid mixtures are generally preferred because they can provide a proper media for copper electrowinning during recovery stages. Sulfuric acid is also a main leaching reagent for copper oxide ores in the mining industry. When processing, e.g., electronic wastes, sulfuric acid along with an oxidizing reagent is generally used to leach copper, however the process is usually slow, not efficient, and requires elevated temperature. Further, when processing, e.g., electronic wastes and using H₂O₂ as the oxidizing agent, the H₂O₂ tends to react exothermically and can decompose into gaseous products during the leaching process. These gaseous products can generate foams during the leaching process, which can slow down the leaching process, can render the leach process less efficient or effective, and can complicate downstream processing (e.g., wastewater treatment, etc.), as the foams tend to be composed of coinage metal-comprising materials.

Common lixiviants for the leaching and/or recovery of silver via hydrometallurgical processes include nitric acid. Particularly, nitric acid is one of the most common media for leaching silver from electronic waste at ambient or elevated temperatures; however, the leaching process is relatively slow. Further, contrary to sulfuric acid, nitric acid can pose an environmental risk, as it can produce large amounts of NOx gas at large scale; it is a more expensive chemical; and, in the presence of an halide source, can start leaching precious metals such as gold. Additionally, nitric acid can act as a relatively strong oxidant when used at high concentrations (e.g., ≥2M). As a result, while nitric acid as a lixiviant can leach both silver and copper, it can also leach and/or breakdown other components (e.g., plastics) of the substance comprising the coinage metal (e.g., electronic waste). The leaching and/or break down of these other components such as plastics can also lead to the formation of foams, which can slow down the leaching process, can render the leach process less efficient or effective, and can complicate downstream processing (e.g., wastewater treatment, etc.), as the foams tend to be composed of coinage metal-comprising materials.

In one or more embodiments of any one of the methods or solution described herein, the methods or use of the solution may provide increased leaching rates for coinage metals (e.g., copper and/or silver) relative to incumbent technologies (e.g., see above). In one or more embodiments, the water-miscible stabilizer can reduce, inhibit, or prevent formation of foams when leaching substances comprising coinage metal (e.g., electronic waste), which can otherwise form in incumbent processes and can slow down the leaching process, can render the leach process less efficient or effective, and can complicate downstream processing (e.g., see above). In one or more embodiments, the water-miscible stabilizer can also facilitate dispersion of powderized substances comprising coinage metal in the aqueous leach solution. In one or more embodiments, facilitating dispersion of a powderized substance facilitates the formation of a relatively homogenous slurry. The formation of a more homogeneous slurry can result in an increase in the surface area of the powderized substance that is in contact with the aqueous leach solution, which can increase leaching rates and decrease leaching times. In incumbent processes, when powderized substances comprising coinage metal are mixed with water or aqueous solutions without a water-miscible stabilizer, hydrophobic components of the substances (e.g., plastics) can agglomerate, and can thus increase leaching times and decrease leaching rates. In one or more embodiments, the increased leaching rates may decrease consumption of H₂O₂ when it is used as the oxidizing agent. In incumbent processes, higher leaching times can result in higher amounts of H₂O₂ being lost due to decomposition and evaporation.

In one or more embodiments of any one of the methods or solution described herein, the methods or use of the solution may provide more environmentally-friendly leaching relative to incumbent technologies (e.g., see above). In one or more embodiments, the methods or use of the solution being more environmentally-friendly for extraction may comprise having reduced environmental and safety restrictions due to the fact that it uses milder conditions (e.g., ambient temperatures) relative to the incumbent technologies. In one or more embodiments, the milder conditions may comprise using safer, less toxic and/or complex chemistry. In one or more embodiments, the milder conditions may comprise using a leach solution that comprises components, such as the leaching acid, that do not generate toxic or noxious gases. In one or more embodiments, using safer, less toxic and/or less complex chemistry may allow for the methods or use of the solution to be more easily implemented industrially, as cheaper, less specialized equipment may be used. This is in contrast to industrial processes that use leaching media or components that produce toxic or noxious gases, the disposal of which would need to be managed. In one or more embodiments, using safer, less toxic and/or less complex chemistry may contribute to a reduction in the operational and capital expenditures associated with carrying out the methods or use of the solution.

In one or more embodiments of any one of the methods or solution described herein, the methods or use of the solution may provide more environmentally-friendly leaching by providing selective leaching of coinage metal, such as copper and/or silver, over precious metals and platinum group metals, such as gold, palladium, platinum, and/or rhodium. In one or more embodiments where the methods or use of the solution provides such selectivity, further copper and/or silver refining steps, such as solvent extraction or precipitation steps, may not be required.

In one or more embodiments of any one of the methods or solution described herein, the methods or use of the solution may provide more environmentally-friendly leaching by exhibiting high leaching yields for coinage metals from a substance comprising coinage metals, such as higher leaching yields relative to leaching yields exhibited by incumbent leaching processes. By leaching/extracting a higher percentage of the coinage metal in a substance, the methods or solution described herein may mitigate the environmental impact of inefficient recycling methods that process wastes containing coinage metal, or the environmental impact of having to mine for further ore deposits to keep up with demand for coinage metals. In one or more embodiments, the substance comprising coinage metals may further comprise precious metals that may also be desirable to extract from the substance. By exhibiting higher leaching yields for coinage metals, thereby removing those metals from the substance, the method and solution described herein may facilitate a more efficient or selective (e.g., requiring less refining steps) downstream process dedicated to the extraction of the precious metals. Therefore, in one or more embodiments, the methods or solution described herein, may reduce the overall amount of waste produced when extracting coinage and/or precious metals.

The following non-limiting examples are illustrative of the present disclosure:

### EXAMPLES

### General Example

In one or more examples, there is provided a method for leaching coinage metal from a substance comprising coinage metal. In one or more examples, the substance is crushed and ground to have an average particle size of <250 microns. In one or more examples, the substance that is crushed and ground to have an average particle size of <250 microns is electronic waste, a coinage metal concentrate, a mining concentrate, or a coinage metal ore. In one or more examples, the substance is electronic waste.

In one or more examples, the substance comprising coinage metal is contacted with a first aqueous leach solution comprising, consisting essentially of, or consisting of a first leaching acid; a first oxidizing agent; and a first water-miscible stabilizer, under conditions to leach a first coinage metal from the substance. In one or more examples, the first stabilizer is a water-miscible monocarboxylic acid, water-miscible polycarboxylic acid, carboxylates thereof, or a combination thereof. In one or more examples, the first stabilizer is acetic acid, carboxylates thereof, or a combination thereof. In one or more examples, the first stabilizer is citric acid, carboxylates thereof, or a combination thereof. In one or more examples, the first leaching acid is an acid having a first pKₐ≤1, or <0, such as H₂SO₄, HNO₃, or a combination thereof. In one or more examples, the first leaching acid is H₂SO₄. In one or more examples, the first oxidizing agent has a standard reduction potential of 0.6V, or 0.65V, such as CuCl₂, FeCl₃, MnO₂, KMnO₄, H₂O₂, Fe₂(SO₄)₃, or a combination thereof. In one or more examples, the first oxidizing agent is H₂O₂ or Fe₂(SO₄)₃. In one or more examples, the first oxidizing agent is Fe₂(SO₄)₃. In one or more examples, the conditions to leach the first coinage metal from the substance comprises contacting the substance and the first aqueous leach solution at ambient temperature and/or pressure, at a solid to liquid ratio of about 1:4 to about 1:10, for a time of about 0.5 hours to about 6 hours.

In one or more examples, following contacting the substance with the first aqueous leach solution and leaching the first coinage metal, the first aqueous leach solution containing the first leached coinage metal is separated from the substance; and then the substance is contacted with a second aqueous leach solution comprising, consisting essentially of, or consisting of a second leaching acid; a second oxidizing agent; and a second water-miscible stabilizer, under conditions to leach a second coinage metal from the substance.

In one or more examples, the second stabilizer is a water-miscible monocarboxylic acid, water-miscible polycarboxylic acid, carboxylates thereof, or a combination thereof. In one or more examples, the second stabilizer is acetic acid, carboxylates thereof, or a combination thereof. In one or more examples, the second stabilizer is citric acid, carboxylates thereof, or a combination thereof. In one or more examples, the second leaching acid is an acid having a first pKₐ≤1, or <0, such as H₂SO₄, HNO₃, or a combination thereof. In one or more examples, the second leaching acid is H₂SO₄. In one or more examples, the second oxidizing agent has a standard reduction potential of 0.6V, or 0.65V, such as CuCl₂, FeCl₃, MnO₂, KMnO₄, H₂O₂, Fe₂(SO₄)₃, or a combination thereof. In one or more examples, the second oxidizing agent is H₂O₂ or Fe₂(SO₄)₃. In one or more examples, the second oxidizing agent is Fe₂(SO₄)₃. In one or more examples, the conditions to leach the second coinage metal from the substance comprises contacting the substance and the second aqueous leach solution at ambient temperature and/or pressure, at a solid to liquid ratio of about 1:4 to about 1:10, for a time of about 0.5 hours to about 6 hours.

In one or more examples, the first coinage metal has standard reduction potential (E⁰_{CM1}), the second coinage metal has standard reduction potential E⁰_{CM2}, and E⁰_{CM2}>E⁰_{CM1}. As such, the first coinage metal is leached during the first contacting of the substance with a leach solution, and the second coinage metal is leached during the second contacting of the substance with a leach solution. In one or more examples, the first coinage metal is copper, and the second coinage metal is silver. In one or more examples, the first contacting of the substance also leaches base metals and/or ferrous metals present in the substance. In one or more examples, the second contacting of the substance leaches the remaining base metals and/or ferrous metals present in the substance.

In one or more examples, the first aqueous leach solution containing the first leached coinage metal is treated the under conditions to obtain the first coinage metal. In one or more examples, the second aqueous leach solution containing the second leached coinage metal is treated the under conditions to obtain the second coinage metal. In one or more examples, the conditions for treating include reduction, electrowinning, ion exchange, metal-salt precipitation, or a combination thereof. In one or more examples, the conditions for treating include electrowinning.

In one or more examples, the first oxidizing agent and/or second oxidizing agent may be regenerated in-situ; for example, for re-use of the first and/or second aqueous leach solution. In one or more example, the first oxidizing agent and/or second oxidizing agent is at least partially reduced during the coinage metal leaching. For example, when the first oxidizing agent and/or second oxidizing agent is Fe₂(SO₄)₃, the oxidizing agent is at least partially reduced from a Fe(III) species to a Fe(II) species. Thus, in one or more examples, regenerating the first oxidizing agent and/or second oxidizing agent involves oxidizing the at least partially reduced oxidizing agent to a higher oxidation state (e.g., its initial oxidations state). For example, when the first oxidizing agent and/or second oxidizing agent is Fe₂(SO₄)₃, the at least partially reduced oxidizing agent is oxidized from a Fe(II) species back to a Fe(III) species.

Thus, in one or more examples, regenerating the first oxidizing agent and/or second oxidizing agent comprises contacting the at least partially reduced oxidizing agent with an aqueous oxidizing solution comprising, consisting essentially of, or consisting of an oxidant; an acid; and optionally a water-miscible stabilizer; under conditions to oxidize the at least partially reduced oxidizing agent to regenerate the first oxidizing agent and/or second oxidizing agent. In one or more examples, the oxidant has a third standard reduction potential (E^{O}₃), the first oxidizing agent and/or second oxidizing agent has a fourth standard reduction potential (E^{O}₄), and E^{O}₃>E^{O}₄, such that the oxidant is a strong enough oxidizing agent to oxidize the at least partially reduced oxidizing agent to a higher oxidation state; for example, when the oxidant is H₂O₂ and the first oxidizing agent and/or second oxidizing agent is Fe₂(SO₄)₃. In one or more examples, oxidant has a standard reduction potential (E^{O}₃)≥0.6V, or ≥0.65V, such as FeCl₃, MnO₂, KMnO₄, H₂O₂, Fe₂(SO₄)₃, or any combination thereof. In one or more examples, the oxidant is MnO₂, KMnO₄, H₂O₂, or a combination thereof. In one or more examples, the oxidant is H₂O₂. In one or more examples, the acid is an acid having a first pKₐ≤1, or <0, such as H₂SO₄, HNO₃, or a combination thereof. In one or more examples, the acid is H₂SO₄. In one or more examples, the stabilizer may or may not be included in the aqueous oxidizing solution. In one or more examples, the optional stabilizer is a water-miscible monocarboxylic acid, water-miscible polycarboxylic acid, carboxylates thereof, or a combination thereof. In one or more examples, the optional stabilizer is acetic acid, carboxylates thereof, or a combination thereof. In one or more examples, the optional stabilizer is citric acid, carboxylates thereof, or a combination thereof. In one or more examples, the conditions to oxidize the at least partially reduced oxidizing agent to regenerate the first oxidizing agent and/or second oxidizing agent comprise contacting the at least partially reduced oxidizing agent with the aqueous oxidizing solution at ambient temperature and/or pressure, for a time of about 1 min to about 1 hour.

In one or more examples, the method for leaching coinage metal from a substance comprising coinage metal provides a better recovery of coinage metal relative to incumbent processes that include, e.g., nitric acid or a H₂SO₄/H₂O₂ mixture as lixiviants. In one or more examples, the method has leaching yield (Y₁) for the first coinage metal and/or the second coinage metal, an incumbent leaching process has leaching yield (Y₂) for the first coinage metal and/or the second coinage metal, and the difference in leaching yield (Y₁−Y₂) is about 10% to about 90%, or about 12% to about 90%, or about 15% to about 90%, or about 20% to about 90%, or about 30% to about 90%, or about 40% to about 90%, or about 45% to about 90%, or about 50% to about 90%, such that the method offers a higher leaching yield (otherwise referred to as a higher recovery) of coinage metals. In one or more examples, the method has leaching yield (Y₁) for the first coinage metal and/or the second coinage metal, an incumbent leaching process has leaching yield (Y₂) for the first coinage metal and/or the second coinage metal, and the percent increase in leaching yield [(Y₁−Y₂)/|Y₂|]×100) is about 10% to about 1500%, or about 20% to about 1200%, or about 20% to about 1100%, or about 20% to about 1000%, or about 20% to about 900%, or about 20% to about 800%, or about 20% to about 700%, or about 20% to about 600%, or about 20% to about 500%, or about 20% to about 400%, or about 20% to about 300%, or about 20% to about 250%, or about 20% to about 200%, or about 20% to about 100%, or about 20% to about 70%, or about 20% to about 60%, or about 20% to about 50%, or about 20% to about 40%, or about 20% to about 30%, such that the method offers a higher leaching yield (otherwise referred to as a higher recovery) of coinage metals.

In one or more examples, the method for leaching coinage metal from a substance comprising coinage metal provides increased leaching rates for coinage metals (e.g., copper and/or silver) relative to incumbent technologies. In one or more examples, use of the first and/or second water-miscible stabilizer can reduce, inhibit, or prevent formation of foams when leaching substances comprising coinage metal. In one or more examples, the water-miscible stabilizer facilitates dispersion of the powder, formed by crushing and grinding the substance to <250 microns in size, in the aqueous leach solution. In one or more examples, facilitating dispersion of the powderized substance facilitates the formation of a relatively homogenous slurry, which can improve leaching efficacy (e.g., increase leaching rates and decrease leaching times).

### Example 1

Materials and Methods

Materials

All chemicals were purchased as reagent grade and used without further purification. Electronic wastes were purchased from different vendors in Canada and Europe. Metallic copper with the purity of 99.9% was purchased from Sigma Aldrich. H₂SO₄ 95%, Nitric acid 68%, and glacial acetic acid were purchased from Fisher Scientific and used as received. H₂O₂ 30%, was purchased from Fisher Scientific. Fe₂(SO₄)₃ 97% was purchased from Sigma Aldrich. Chemical analysis was carried out using Fisher Scientific FAA-SpectrAA iCE3300 instrument.

Methods

Atomic Absorption Spectroscopy (AAS):

All chemical analysis in the lab was carried out using Fisher Scientific FAA-SpectrAA iCE3300 instrument. 324.8 nm was used as selected wavelengths for copper. Standard Cu solution (1 ppm, 5 ppm, 10 ppm) were prepared from a commercial standard (1000 ppm Cu,). The digested metals in both nitric acid and studied solutions were analyzed with the machine after proper dilution (diluted between >1 ppm to <10 ppm Cu). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.5; Fuel flow (L/min): 1.1; Burner height (mm): 7.0; Gas flow (L/min): 1.1

General Experimental for Leaching Metallic Copper

Metallic copper powder (50 mg, with the particle size of <250 microns) was added to 10 mL leach solution including appropriate amounts of sulfuric acid, oxidant, and stabilizer and stirred at 200 rpm for an appropriate time period at room temperature under ambient pressure. Leaching efficiency of different solutions was measured by AAS in different time frames (Table 1.1).

A Specific Experimental for Leaching Metallic Copper

50 mg metallic copper powder (with the particle size of <250 microns) was added to 10 mL aqueous solution containing 0.54 ml H₂SO₄ 98%, 0.20 ml H₂O₂ 30%, and 1.00 ml glacial acetic acid (99.9%), and stirred at 200 rpm for 180 min at room temperature under ambient pressure. The resulting solution was then separated from the remaining copper powder and analysed by AAS. 4988 ppm was leached in the solution resulting in 99.8% leaching efficiency (Table 1.1).

General Experimental for Extraction of Copper from Wound IC-Chips

Ground IC-Chips (2.5 g, with the particle size of <250 microns) was added to 10 mL leach solution including appropriate amounts of sulfuric acid, oxidant, and stabilizer and stirred at 500 rpm for an appropriate time period at room temperature under ambient pressure. Leaching efficiency of different solutions was measured by AAS in different time frames (Table 1.2).

A Specific Experimental for Extraction of Copper from Wound IC-Chips

2.50 g ground IC-Chips (with the particle size of <250 microns) was added to 10 mL aqueous solution (solid to liquid phase ratio of 1:4) containing 1.08 ml H₂SO₄ 98%, 1.50 ml H₂O₂ 30%, and 1.00 ml glacial acetic acid (99.9%), and stirred at 500 rpm for 120 min at room temperature under ambient pressure. The resulting solution was then separated from the remaining powder and analysed by AAS. 59963 ppm copper was leached from the powder. The treated powder was then rinsed with water and treated in 20 ml 6M HNO₃ solution at 80° C. for 120 min to leach the remaining copper. The AAS analysis showed only 257 ppm copper was left in the powder, showing 99.6% leaching efficiency (Table 1.2).

2.50 g ground IC-Chips (with the particle size of <250 microns) was added to 25 mL aqueous solution (solid to liquid phase ratio of 1:10) containing 0.013 ml H₂SO₄ 98%, 3.94.08 g Fe₂(SO₄)₃·7H₂O, and 1.25 ml glacial acetic acid (99.9%), and stirred at 500 rpm for 60 min at room temperature under ambient pressure. The resulting solution was then separated from the remaining powder and analysed by AAS. 59832 ppm copper was leached from the powder. The treated powder was then rinsed with water and treated in 20 ml 6M HNO₃ solution at 80° C. for 120 min to leach the remaining copper. The AAS analysis showed only 137 ppm copper was left in the powder, showing 99.8% leaching efficiency (Table 1.2).

The filtrate was mixed with 0.39 ml H₂SO₄, 1.41 ml H₂O₂ 30%, and 0.250 ml glacial acetic acid (99.9%) and stirred for 10 min. then, 2.50 g ground IC-Chips (with the particle size of <250 microns) was added to the solution and stirred at 500 rpm for 60 min at room temperature under ambient pressure. The resulting solution was then separated from the remaining powder and analysed by AAS. 59722 ppm copper was leached from the powder. The treated powder was then rinsed with water and treated in 20 ml 6M HNO₃ solution at 80° C. for 120 min to leach the remaining copper. The AAS analysis showed only 320 ppm copper was left in the powder, showing 99.5% leaching efficiency.

Results and Discussion

It was observed that adding acetic acid as a stabilizer to the aqueous solution of H₂SO₄/H₂O₂ could improve the leaching efficiency of the solution to extract copper. The following tables show the copper leaching improvement after adding acetic acid to the aqueous leach solution in both cases of metallic copper and ground IC-Chips.

TABLE 1.1

| | | | | | Leached | |
|---|---|---|---|---|---|---|
| | [H₂SO₄] | [H₂O₂] | [AcOH] | Time | Cu | Leaching |
| Experiment | (mol/L) | (%) | (%) | (min) | (ppm) | yield |
| 1 | 1 | 1 | — | 60 | 1520 | 30.4% |
| 2 | 1 | 1 | 1 | 60 | 1592 | 30.8% |
| 3 | 1 | 1 | 5 | 60 | 1832 | 36.6% |
| 4 | 1 | 1 | 20 | 60 | 2104 | 42.1% |
| 6 | 1 | 1 | — | 120 | 2064 | 41.3% |
| 7 | 1 | 1 | 1 | 120 | 2104 | 42.1% |
| 8 | 1 | 1 | 5 | 120 | 2384 | 47.7% |
| 9 | 1 | 1 | 20 | 120 | 2832 | 56.6% |
| 11 | 1 | 1 | — | 180 | 2665 | 53.3% |
| 12 | 1 | 1 | 1 | 180 | 2672 | 53.4% |
| 13 | 1 | 1 | 5 | 180 | 3232 | 64.6% |
| 14 | 1 | 1 | 20 | 180 | 3808 | 76.2% |
| 15 | 1 | 2 | 10 | 180 | 4988 | 99.8% |

TABLE 1.2

| | | | | | Leached | | |
|---|---|---|---|---|---|---|---|
| | [H₂SO₄] | | [AcOH] | Time | Cu | Remaining | Extraction |
| Experiment | (mol/L) | [Oxidant] (%) | (%) | (min) | (ppm) | Cu (ppm) | yield |
| 1 | 2 | [H₂O₂] (15) | — | 60 | 28805 | 23477 | 55.1% |
| 2 | 2 | [H₂O₂] (15) | — | 180 | 47655 | 11979 | 80.0% |
| 3 | 2 | [H₂O₂] (15) | 10 | 60 | 49213 | 8377 | 85.5% |
| 4 | 2 | [H₂O₂] (15) | 10 | 120 | 59963 | 257 | 99.6% |
| 5 | 2 | [H₂O₂] (15) | 5 | 180 | 59776 | 262 | 99.5% |
| 6 | 0.01 | [Fe₂(SO₄)₃•7H₂O] | 5 | 60 | 59832 | 137 | 99.8% |
| | | (0.3) | | | | | |

### Example 2

Materials and Methods

Materials

All chemicals were purchased as reagent grade and used without further purification. Electronic wastes were purchased from different vendors in Canada and Europe. Metallic silver with the purity of 99.9% was purchased from Sigma Aldrich. H₂SO₄ 95%, Nitric acid 68%, citric acid, and glacial acetic acid were purchased from Fisher Scientific and used as received. H₂O₂ 30%, was purchased from Fisher Scientific. Fe₂(SO₄)₃ 97% was purchased from Sigma Aldrich. Chemical analysis was carried out using Fisher Scientific FAA-SpectrAA iCE3300 instrument.

Methods

Atomic Absorption Spectroscopy (AAS):

All chemical analysis in the lab was carried out using Fisher Scientific FAA-SpectrAA iCE3300 instrument. 328.1 nm was used as selected wavelengths for silver. Standard Ag solution (1 ppm, 5 ppm, 10 ppm) were prepared from a commercial standard (1000 ppm Ag,). The digested metals in both nitric acid and studied solutions were analyzed with the machine after proper dilution (diluted between >1 ppm to <10 ppm Ag). A mixture of air and acetylene was used for all analysis. All other parameters were automatically adjusted by the instrument itself. For example, the following parameters were set for palladium analysis: Lamp current (%): 75; Measurement time (5): 4.0; Bandpass (nm): 0.5; Fuel flow (L/min): 1.1; Burner height (mm): 7.0; Gas flow (L/min): 1.1

General Experimental for Leaching Metallic Silver

Metallic silver powder (50 mg, with the particle size of <250 microns) was added to 10 mL leach solution including appropriate amounts of sulfuric acid, oxidant, and stabilizer and stirred at 200 rpm for an appropriate time period at room temperature under ambient pressure. Leaching efficiency of different solutions was measured by AAS in different time frames (Table 2.1).

A Specific Experimental for Leaching Metallic Silver

50 mg metallic silver powder (with the particle size of <250 microns) was added to 10 mL aqueous solution containing 1.08 ml H₂SO₄ 98%, 1.00 ml H₂O₂ 30%, and 1.00 ml glacial acetic acid (99.9%), and stirred at 200 rpm for 120 min at room temperature under ambient pressure. The resulting solution was then separated from the remaining silver powder and analyzed by AAS. 4240 ppm silver was leached in the solution resulting in 84.8% leaching efficiency (Table 2.1).

General Experimental for Extraction of Metallic Silver from Wound IC-Chips

Ground IC-Chips (2.5 g, with the particle size of <250 microns) was added to 10 mL leach solution including appropriate amounts of sulfuric acid, oxidant, and stabilizer and stirred at 500 rpm for an appropriate time period at room temperature under ambient pressure. Leaching efficiency of different solutions was measured by AAS in different time frames (Table 2.2).

A Specific Experimental for Extraction of Metallic Silver from Wound IC-Chips

2.50 g ground IC-Chips (with the particle size of <250 microns) was added to 10 mL aqueous solution (solid to liquid phase ratio of 1:4) containing 1.08 ml H₂SO₄ 98%, 1.50 ml H₂O₂ 30%, and 1.00 ml glacial acetic acid (99.9%), and stirred at 500 rpm for 180 min at room temperature under ambient pressure. The resulting solution was then separated from the remaining powder and analysed by AAS. 2155 ppm silver was leached from the powder in to the solution. The treated powder was then rinsed with water and treated in 20 ml 6M HNO₃ solution at 80° C. for 120 min to leach the remaining silver. The AAS analysis showed only 62 ppm silver was left in the powder, showing 97.2% leaching efficiency (Table 2.2).

2.50 g ground IC-Chips (with the particle size of <250 microns) was added to 25 mL aqueous solution (solid to liquid phase ratio of 1:10) containing 0.013 ml H₂SO₄ 98%, 3.94 g Fe₂(SO₄)₃·7H₂O, and 1.25 ml glacial acetic acid (99.9%), and stirred at 500 rpm for 60 min at room temperature under ambient pressure. The resulting solution was then separated from the remaining powder and analysed by AAS. 2165 ppm silver was leached from the powder into the solution. The treated powder was then rinsed with water and treated in 20 ml 6M HNO₃ solution at 80° C. for 120 min to leach the remaining silver. The AAS analysis showed only 80 ppm silver was left in the powder, showing 96.3% leaching efficiency (Table 2.2).

Results and Discussion

It was observed that adding acetic acid or citric acid as a stabilizer to the aqueous solution of H₂SO₄/H₂O₂ could improve the leaching efficiency of the solution to extract silver. The following tables show the silver leaching improvement after adding acetic acid or citric acid to the aqueous leach solution in both cases of metallic silver and ground IC-Chips.

TABLE 2.1

| | [H₂SO₄] | [H₂O₂] | [AcOH] | [Citric acid] | Time | Leached | Leaching |
|---|---|---|---|---|---|---|---|
| Experiment | (mol/L) | (%) | (%) | (%) | (min) | Ag (ppm) | yield |
| 1 | 2 | 10 | — | — | 60 | 922 | 18.4% |
| 2 | 2 | 10 | 1 | — | 60 | 1554 | 31.1% |
| 3 | 2 | 10 | 3 | — | 60 | 2712 | 54.2% |
| 4 | 2 | 10 | 5 | — | 60 | 2410 | 48.2% |
| 5 | 2 | 10 | 10 | — | 60 | 3050 | 61.0% |
| 6 | 2 | 10 | 20 | — | 60 | 3155 | 63.1% |
| 7 | 2 | 10 | — | — | 120 | 1648 | 32.9% |
| 8 | 2 | 10 | 1 | — | 120 | 2656 | 53.1% |
| 9 | 2 | 10 | 3 | — | 120 | 3568 | 71.3% |
| 10 | 2 | 10 | 5 | — | 120 | 3730 | 74.6% |
| 11 | 2 | 10 | 10 | — | 120 | 4240 | 84.8% |
| 12 | 2 | 10 | 20 | — | 120 | 4030 | 80.6% |
| 13 | 2 | 10 | — | — | 180 | 1968 | 39.3% |
| 14 | 2 | 10 | 1 | — | 180 | 2728 | 54.56% |
| 15 | 2 | 10 | 3 | — | 180 | 3624 | 72.5% |
| 16 | 2 | 10 | 5 | — | 180 | 3920 | 78.4% |
| 17 | 2 | 10 | 10 | — | 180 | 4530 | 90.6% |
| 18 | 2 | 10 | 20 | — | 180 | 4025 | 80.5% |
| 19 | 2 | 10 | — | 5 | 60 | 1070 | 21.4% |
| 20 | 2 | 10 | — | 5 | 120 | 2000 | 40.0% |
| 21 | 2 | 10 | — | 5 | 180 | 2280 | 45.6% |
| 22 | 2 | 10 | 10 | — | 360 | 4980 | 99.6% |

TABLE 2.2

| | | | | | Leached | | |
|---|---|---|---|---|---|---|---|
| | [H₂SO₄] | [Oxidant] | [AcOH] | Time | Ag | Remaining | Extraction |
| Experiment | (mol/L) | (%) | (%) | (min) | (ppm) | Ag (ppm) | yield |
| 1 | 2 | [H₂O₂] (15) | — | 60 | 166 | 1985 | 7.7% |
| 2 | 4 | [H₂O₂] (15) | — | 60 | 273 | 1916 | 12.5% |
| 3 | 2 | [H₂O₂] (15) | 10 | 60 | 1675 | 511 | 76.6% |
| 4 | 2 | [H₂O₂] (15) | 10 | 120 | 1988 | 198 | 90.9% |
| 5 | 2 | [H₂O₂] (15) | 10 | 180 | 2155 | 62 | 97.2% |
| 6 | 0.01 | [Fe₂(SO₄)₃•7H₂O] | 5 | 60 | 2165 | 80 | 96.3% |
| | | (0.3) | | | | | |

### Example 3

Materials and Methods

Materials

All chemicals were purchased as reagent grade and used without further purification. Electronic wastes were purchased from different vendors in Canada and Europe. Metallic copper with the purity of 99.9% was purchased from Sigma Aldrich. Metallic silver with the purity of 99.9% was purchased from Sigma Aldrich. H₂SO₄ 95%, Nitric acid 68%, citric acid, and glacial acetic acid were purchased from Fisher Scientific and used as received. H₂O₂ 30%, was purchased from Fisher Scientific. Fe₂(SO₄)₃ 97% was purchased from Sigma Aldrich. Chemical analysis was carried out using Fisher Scientific FAA-SpectrAA iCE3300 instrument.

Methods

Atomic Absorption Spectroscopy (AAS):

All chemical analysis in the lab was carried out using Fisher Scientific FAA-SpectrAA iCE3300 instrument. 324.8 nm was used as selected wavelengths for copper. Standard Cu solution (1 ppm, 5 ppm, 10 ppm) were prepared from a commercial standard (1000 ppm Cu,). The digested metals in both nitric acid and studied solutions were analyzed with the machine after proper dilution (diluted between >1 ppm to <10 ppm Cu). 328.1 nm was used as selected wavelengths for silver. Standard Ag solution (1 ppm, 5 ppm, 10 ppm) were prepared from a commercial standard (1000 ppm Ag,). The digested metals in both nitric acid and studied solutions were analyzed with the machine after proper dilution (diluted between >1 ppm to <10 ppm Ag). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.5; Fuel flow (L/min): 1.1; Burner height (mm): 7.0; Gas flow (L/min): 1.1

Obsolete printed circuit boards were depopulated manually and the obtained electronic components including capacitors, resistors, diodes, transistors, etc., were crushed below 250 microns using a laboratory ball mill. 2.50 g of this powder was added to 10 mL aqueous solution (solid to liquid phase ratio of 1:4) containing 1.08 ml H₂SO₄ 98%, 1.50 ml H₂O₂ 30%, and stirred at 500 rpm for 90 min at room temperature under ambient pressure. The resulting solution was then separated from the remaining powder and analysed by AAS. 33800 ppm copper was leached from the powder. The treated powder was then rinsed with water and treated in 20 ml 6M HNO₃ solution at 80° C. for 120 min to leach the remaining copper. The AAS analysis showed 8750 ppm copper was left in the powder, showing 79.4% leaching efficiency. The treated powder was mixed with 10 mL aqueous solution (solid to liquid phase ratio of 1:4) containing 1.08 ml H₂SO₄ 98%, 1.50 ml H₂O₂ 30%, and stirred at 500 rpm for 90 min at room temperature under ambient pressure. The resulting solution was then separated from the remaining powder and analysed by AAS. 1901 ppm silver was leached from the powder. The treated powder was then rinsed with water and treated in 20 ml 6M HNO₃ solution at 80° C. for 120 min to leach the remaining silver. The AAS analysis showed 2245 ppm silver was left in the powder, showing 45.8% leaching efficiency.

Obsolete printed circuit boards were depopulated manually and the obtained electronic components including capacitors, resistors, diodes, transistors, etc were crushed below 250 microns using a laboratory ball mill. 2.50 g of this powder was added to 10 mL aqueous solution (solid to liquid phase ratio of 1:4) containing 1.08 ml H₂SO₄ 98%, 1.50 ml H₂O₂ 30%, and 1.00 ml glacial acetic acid (99.9%), and stirred at 500 rpm for 90 min at room temperature under ambient pressure. The resulting solution was then separated from the remaining powder and analysed by AAS. 40107 ppm copper was leached from the powder. The treated powder was then rinsed with water and treated in 20 ml 6M HNO₃ solution at 80° C. for 120 min to leach the remaining copper. The AAS analysis showed 652 ppm copper was left in the powder, showing 98.4% leaching efficiency. The treated powder was mixed with 10 mL aqueous solution (solid to liquid phase ratio of 1:4) containing 1.08 ml H₂SO₄ 98%, 1.50 ml H₂O₂ 30%, and 1.00 ml glacial acetic acid (99.9%), and stirred at 500 rpm for 90 min at room temperature under ambient pressure. The resulting solution was then separated from the remaining powder and analysed by AAS. 3776 ppm silver was leached from the powder. The treated powder was then rinsed with water and treated in 20 ml 6M HNO₃ solution at 80° C. for 120 min to leach the remaining copper. The AAS analysis showed 338 ppm silver was left in the powder, showing 91.8% leaching efficiency.

### Example 4

Materials and Methods

Materials

All chemicals were purchased as reagent grade and used without further purification. Electronic wastes were purchased from different vendors in Canada and Europe. Metallic copper with the purity of 99.9% was purchased from Sigma Aldrich. Metallic silver with the purity of 99.9% was purchased from Sigma Aldrich. H₂SO₄ 95%, Nitric acid 68%, citric acid, and glacial acetic acid were purchased from Fisher Scientific and used as received. H₂O₂ 30%, was purchased from Fisher Scientific. Fe₂(SO₄)₃ 97% was purchased from Sigma Aldrich. Sodium acetate 99% was purchased from Sigma Aldrich. Chemical analysis was carried out using Fisher Scientific FAA-SpectrAA iCE3300 instrument.

Methods

Atomic Absorption Spectroscopy (AAS):

All chemical analysis in the lab was carried out using Fisher Scientific FAA-SpectrAA iCE3300 instrument. 324.8 nm was used as selected wavelengths for copper. Standard Cu solution (1 ppm, 5 ppm, 10 ppm) were prepared from a commercial standard (1000 ppm Cu,). The digested metals in both nitric acid and studied solutions were analyzed with the machine after proper dilution (diluted between >1 ppm to <10 ppm Cu). 328.1 nm was used as selected wavelengths for silver. Standard Ag solution (1 ppm, 5 ppm, 10 ppm) were prepared from a commercial standard (1000 ppm Ag,). The digested metals in both nitric acid and studied solutions were analyzed with the machine after proper dilution (diluted between >1 ppm to <10 ppm Ag). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.5; Fuel flow (L/min): 1.1; Burner height (mm): 7.0; Gas flow (L/min): 1.1

Obsolete printed circuit boards were depopulated manually and the obtained electronic components including capacitors, resistors, diodes, transistors, etc were crushed below 250 microns using a laboratory ball mill. 2.50 g of this powder was added to 10 mL aqueous solution (solid to liquid phase ratio of 1:4) containing 1.08 ml H₂SO₄ 98%, 1.50 ml H₂O₂ 30%, and 1.36 g sodium acetate, and stirred at 500 rpm for 90 min at room temperature under ambient pressure. The resulting solution was then separated from the remaining powder and analysed by AAS. 40123 ppm copper was leached from the powder. The treated powder was then rinsed with water and treated in 20 ml 6M HNO₃ solution at 80° C. for 120 min to leach the remaining copper. The AAS analysis showed 645 ppm copper was left in the powder, showing 98.4% leaching efficiency. The treated powder was mixed with 10 mL aqueous solution (solid to liquid phase ratio of 1:4) containing 1.08 ml H₂SO₄ 98%, 1.50 ml H₂O₂ 30%, and 1.36 g sodium acetate, and stirred at 500 rpm for 90 min at room temperature under ambient pressure. The resulting solution was then separated from the remaining powder and analysed by AAS. 3758 ppm silver was leached from the powder. The treated powder was then rinsed with water and treated in 20 ml 6M HNO₃ solution at 80° C. for 120 min to leach the remaining silver. The AAS analysis showed 345 ppm silver was left in the powder, showing 91.6% leaching efficiency.

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

1. A method of leaching coinage metal from a substance comprising coinage metal, the method comprising contacting the substance with an aqueous leach solution comprising:
(a) a leaching acid;
(b) an oxidizing agent; and
(c) a water-miscible stabilizer,
under conditions to leach the coinage metal from the substance.

2. The method of claim 1, wherein each of the leaching acid, oxidizing agent, and water-miscible stabilizer is a different chemical compound.

3. The method of claim 1 or 2, wherein the stabilizer is a water-miscible carboxylic acid having a first pKₐ≥3.

4. The method of any one of claims 1 to 3, wherein the stabilizer is a water-miscible monocarboxylic acid, water-miscible polycarboxylic acid, carboxylates thereof, or a combination thereof.

5. The method of any one of claims 1 to 4, wherein the stabilizer is a water-miscible C₂-C₅ monocarboxylic acid, carboxylates thereof, or a combination thereof.

6. The method of claim 5, wherein the water-miscible monocarboxylic acid is acetic acid, carboxylates thereof, or a combination thereof.

7. The method of any one of claims 1 to 6, wherein the stabilizer is a water-miscible C₂-C₈ polycarboxylic acid, carboxylates thereof, or a combination thereof.

8. The method of claim 7, wherein the water-miscible polycarboxylic acid is citric acid, carboxylates thereof, or a combination thereof.

9. The method of any one of claims 1 to 8, wherein the stabilizer is <50% (vol/vol), or ≥20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the leach solution.

10. The method of any one of claims 1 to 9, wherein the leaching acid is an acid having a first pKₐ≤1, or <0.

11. The method of any one of claims 1 to 10, wherein the leaching acid is H₂SO₄, HNO₃, or a combination thereof.

12. The method of any one of claims 1 to 11, wherein the leaching acid is H₂SO₄.

13. The method of claim 12, wherein the H₂SO₄ is at a concentration of about 0.01M to about 5M, or about 0.01M to about 2M, or about 0.01M to about 1M, or about 0.01M to about 0.5M.

14. The method of any one of claims 1 to 11, wherein the leaching acid is HNO₃ at a concentration of <2M, or about 1M to about 2M, or <1M.

15. The method of any one of claims 1 to 14, wherein the leaching acid is not HNO₃.

16. The method of any one of claims 1 to 15, wherein the oxidizing agent has a standard reduction potential of ≥0.6V, ≥0.65V or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V.

17. The method of any one of claims 1 to 16, wherein the oxidizing agent is CuCl₂, FeCl₃, MnO₂, KMnO₄, H₂O₂, Fe₂(SO₄)₃, or a combination thereof.

18. The method of any one of claims 1 to 17, wherein the oxidizing agent is H₂O₂ or Fe₂(SO₄)₃, or combination thereof.

19. The method of any one of claims 1 to 18, wherein the oxidizing agent is H₂O₂.

20. The method of claim 19, wherein the H₂O₂ is about 1% to about 20% (vol/vol), or about 5% to about 15% (vol/vol), or about 10% to about 15% (vol/vol), or about 15% (vol/vol) of the leach solution.

21. The method of any one of claims 1 to 18, wherein the oxidizing agent is Fe₂(SO₄)₃.

22. The method of claim 21, wherein the Fe₂(SO₄)₃ is about 0.1% to about 5% (vol/vol), or about 0.1% to about 1% (vol/vol), or about 0.1% to about 0.5% (vol/vol), or about 0.3% (vol/vol) of the leach solution.

23. The method of any one of claims 1 to 22, wherein the method further comprises:
separating the leach solution containing the leached coinage metal from insoluble impurities;
treating the leached coinage metal in the leach solution under conditions to obtain the coinage metal; and
separating the coinage metal from the leach solution.

24. The method of claim 23, wherein treating the leached coinage metal in the leach solution under conditions to obtain the coinage metal comprises reduction, electrowinning, ion exchange, metal-salt precipitation, or a combination thereof.

25. The method of claim 23 or 24, wherein treating the leached coinage metal in the leach solution under conditions to obtain the coinage metal comprises electrowinning.

26. The method of any one of claims 1 to 25, wherein the conditions to leach the coinage metal from the substance comprises contacting the substance comprising the coinage metal and the leach solution at ambient temperature and/or pressure.

27. The method of any one of claims 1 to 25, wherein the conditions to leach the coinage metal from the substance comprises contacting the substance comprising the coinage metal and the leach solution at a temperature between about 20° C. to <80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.

28. The method of any one of claims 1 to 27, wherein the conditions to leach the coinage metal from the substance comprises contacting the substance comprising the coinage metal and the leach solution at a solid to liquid ratio of about 1:4, or about 1:5, or about 1:6, or about or about 1:7, or about 1:8, or about 1:9, or about 1:10.

29. The method of any one of claims 1 to 28, wherein the conditions to leach the coinage metal from the substance comprises contacting the substance comprising the coinage metal and the leach solution for a time of about 0.5 hours to about 6 hours, or about 1 hour to about 6 hours, or about 1 hour or about 3 hours, or about 1 hour to about 2 hours.

30. The method of any one of claims 1 to 29, further comprising grinding the substance into particles having a size of ≤250 microns.

31. The method of any one of claims 1 to 30, wherein the substance comprising coinage metal comprises ores, coinage metal-concentrates, mining concentrates (e.g., Cu and/or Ag mining concentrates), electronic waste, jewelry, automotive components, building components, tools, musical instruments, medical equipment, industrial machinery, soldering or brazing materials, soldered or brazed components, coins, solar panels, catalysts, mirror components, glass components, multilayer ceramic chip capacitor (MLCC), spent silver oxide batteries, or a combination thereof.

32. The method of any one of claims 1 to 31, wherein the substance comprising coinage metal comprises ores, coinage metal-concentrates, mining concentrates, or electronic waste.

33. The method of claim 32, wherein the electronic waste comprises electronic equipment or components thereof.

34. The method of any one of claims 31 to 33, wherein the electronic waste comprises motherboards, chip resistors, chip semiconductors, printed circuit boards, integrated circuit chips, or a combination thereof.

35. The method of any one of claims 1 to 34, wherein the substance comprising coinage metal is a substance comprising copper and/or silver.

36. The method of claim 35, wherein the substance comprising copper and/or silver further comprises gold, palladium, rhodium, and/or platinum, and the method selectively dissolves the copper and/or silver from the substance.

37. The method of any one of claims 1 to 36, further comprising leaching base metals and/or ferrous metals from the substance comprising coinage metal.

38. The method of any one of claims 1 to 37, wherein the leached coinage metal is copper.

39. The method of any one of claims 1 to 38, wherein the leached coinage metal is silver.

40. The method of any one of claims 1 to 39, wherein the leached coinage metal is copper and silver.

41. The method of any one of claims 1 to 40, further comprising regenerating the oxidizing agent.

42. The method of any one of claims 1 to 41, wherein the oxidizing agent is regenerated in-situ, optionally for re-use of the aqueous leach solution.

43. The method of claim 41 or 42, wherein the oxidizing agent is at least partially reduced and regenerating the oxidizing agent comprises contacting the at least partially reduced oxidizing agent with an aqueous oxidizing solution comprising:
(a) an oxidant;
(b) an acid; and
(c) optionally a water-miscible stabilizer;
under conditions to oxidize the at least partially reduced oxidizing agent to regenerate the oxidizing agent.

44. The method of claim 43, wherein each of the oxidant, acid, and water-miscible stabilizer is a different chemical compound.

45. The method of claim 43 or 44, wherein the oxidant has a first standard reduction potential (E^{O}₁), the oxidizing agent has a second standard reduction potential (E^{O}₂), and E^{O}₁>E^{O}₂.

46. The method of claim 45, wherein oxidant has a standard reduction potential (E^{O}₁)≥0.6V, ≥0.65V, or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V.

47. The method of any one of claims 43 to 46, wherein oxidant comprises FeCl₃, MnO₂, KMnO₄, H₂O₂, Fe₂(SO₄)₃, or any combination thereof.

48. The method of claim 47, wherein the oxidant is MnO₂, KMnO₄, H₂O₂, or a combination thereof.

49. The method of claim 48, wherein the oxidant is H₂O₂.

50. The method of any one of claims 43 to 49, wherein the acid is an acid having at least one pKₐ≤1, or <0.

51. The method of claim 50, wherein the acid is H₂SO₄, HNO₃, or a combination thereof.

52. The method of claim 51, wherein the acid is H₂SO₄.

53. The method of any one of claims 43 to 52, wherein the stabilizer is a water-miscible carboxylic acid having a first pKₐ≥3.

54. The method of claim 53, wherein the stabilizer is a water-miscible monocarboxylic acid, water-miscible polycarboxylic acid, carboxylates thereof, or a combination thereof.

55. The method of claim 53 or 54, wherein the stabilizer is a water-miscible C₂-C₅ monocarboxylic acid, carboxylates thereof, or a combination thereof; wherein preferably the water-miscible monocarboxylic acid is acetic acid, carboxylates thereof, or a combination thereof.

56. The method of any one of claims 53 to 55, wherein the stabilizer is a water-miscible C₂-C₈ polycarboxylic acid, carboxylates thereof, or a combination thereof; wherein preferably the water-miscible polycarboxylic acid is citric acid, carboxylates thereof, or a combination thereof.

57. The method of any one of claims 43 to 56, wherein the conditions comprise contacting the at least partially reduced oxidizing agent with the aqueous oxidizing solution at ambient temperature and/or pressure.

58. The method of any one of claims 43 to 57, wherein the conditions comprise contacting the at least partially reduced oxidizing agent with the aqueous oxidizing solution at a temperature between about 20° C. to about 80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.

59. The method of any one of claims 43 to 58, wherein the conditions to oxidize the at least partially reduced oxidizing agent to regenerate the oxidizing agent comprise contacting the at least partially reduced oxidizing agent with the aqueous oxidizing solution for a time of about 1 min to about 1 hour, or about 5 min to about 45 min, or about 10 min to about 30 min.

60. A method of leaching coinage metal from a substance comprising coinage metal, the method comprising contacting the substance with an aqueous leach solution comprising:
(a) H₂SO₄ as a leaching acid;
(b) Fe₂(SO₄)₃, H₂O₂ or combination thereof as an oxidizing agent; and
(c) acetic acid, citric acid, or a combination thereof as an water-miscible stabilizer,
under ambient temperatures and/or pressures to leach the coinage metal from the substance.

61. The method of claim 60, wherein the H₂SO₄ is at a concentration of about 0.01M to about 5M, or about 0.01M to about 2M, or about 0.01M to about 1M, or about 0.01M to about 0.5M.

62. The method of claim 60 or 61, wherein the oxidizing agent is H₂O₂, preferably at about 1% to about 20% (vol/vol), or about 5% to about 15% (vol/vol), or about 10% to about 15% (vol/vol), or about 15% (vol/vol) of the leach solution.

63. The method of any one of claims 60 to 62, wherein the oxidizing agent is Fe₂(SO₄)₃, preferably at about 0.1% to about 5% (vol/vol), or about 0.1% to about 1% (vol/vol), or about 0.1% to about 0.5% (vol/vol), or about 0.3% (vol/vol) of the leach solution.

64. The method of any one of claims 60 to 63, wherein the stabilizer is <50% (vol/vol), or 20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the leach solution.

65. The method of any one of claims 60 to 64, further comprising grinding the substance into particles having a size of ≤250 microns.

66. The method of any one of claims 60 to 65, wherein the substance comprising coinage metal comprises ores, coinage metal-concentrates, mining concentrates (e.g., Cu and/or Ag mining concentrates), electronic waste, jewelry, automotive components, building components, tools, musical instruments, medical equipment, industrial machinery, soldering or brazing materials, soldered or brazed components, coins, solar panels, catalysts, mirror components, glass components, multilayer ceramic chip capacitor (MLCC), spent silver oxide batteries, or a combination thereof.

67. The method of any one of claims 60 to 66, wherein the substance comprising coinage metal comprises ores, coinage metal-concentrates, mining concentrates, or electronic waste.

68. The method of claim 67, wherein the electronic waste comprises electronic equipment or components thereof.

69. The method of any one of claims 66 to 68, wherein the electronic waste comprises motherboards, chip resistors, chip semiconductors, printed circuit boards, integrated circuit chips, or a combination thereof.

70. The method of any one of claims 60 to 69, wherein the substance comprising coinage metal is a substance comprising copper and/or silver.

71. The method of any one of claims 60 to 70, further comprising:
separating the leach solution containing the leached coinage metal from insoluble impurities;
treating the leached coinage metal in the leach solution under conditions to obtain the coinage metal; and
separating the coinage metal from the leach solution.

72. The method of claim 71, wherein treating the leached coinage metal in the leach solution under conditions to obtain the coinage metal comprises reduction, electrowinning, ion exchange, metal-salt precipitation, or a combination thereof.

73. The method of claim 71 or 72, wherein treating the leached coinage metal in the leach solution under conditions to obtain the coinage metal comprises electrowinning.

74. The method of any one of claims 60 to 73, wherein the leached coinage metal is copper.

75. The method of any one of claims 60 to 74, wherein the leached coinage metal is silver.

76. The method of any one of claims 60 to 75, wherein the leached coinage metal is copper and silver.

77. The method of any one of claims 1 to 76, wherein the leaching yield of the coinage metal is >65%, >70%, or >75%, or >80%, or >85%, or >90%, or >95%, or >98%, or >99%; preferably >80%, or >85%, >90%, or >95%, or >98%, or >99%.

78. The method of any one of claims 1 to 77, wherein the method has leaching yield (Y₁) the coinage metal, an incumbent leaching process has leaching yield (Y₂) of the coinage metal, and the difference in leaching yield (Y₁−Y₂) is about 10% to about 90%, or about 12% to about 90%, or about 15% to about 90%, or about 20% to about 90%, or about 30% to about 90%, or about 40% to about 90%, or about 45% to about 90%, or about 50% to about 90%.

79. The method of any one of claims 1 to 78, wherein the method has leaching yield (Y₁) of the coinage metal, an incumbent leaching process has leaching yield (Y₂) of the coinage metal, and the percent increase in leaching yield [(Y₁−Y₂)/|Y₂|]×100) is about 10% to about 1500%, or about 20% to about 1200%, or about 20% to about 1100%, or about 20% to about 1000%, or about 20% to about 900%, or about 20% to about 800%, or about 20% to about 700%, or about 20% to about 600%, or about 20% to about 500%, or about 20% to about 400%, or about 20% to about 300%, or about 20% to about 250%, or about 20% to about 200%, or about 20% to about 100%, or about 20% to about 70%, or about 20% to about 60%, or about 20% to about 50%, or about 20% to about 40%, or about 20% to about 30%.

80. An aqueous leach solution for use in leaching coinage metal from a substance comprising coinage metal, the solution comprising:
(a) a leaching acid;
(b) an oxidizing agent; and
(c) a water-miscible stabilizer.

81. The solution of claim 81, wherein each of the leaching acid, oxidizing agent, and water-miscible stabilizer is a different chemical compound.

82. The solution of claim 80 or 81, wherein the stabilizer is a water-miscible carboxylic acid having a first pKₐ≥3.

83. The solution of any one of claims 80 to 82, wherein the stabilizer is a water-miscible monocarboxylic acid, water-miscible polycarboxylic acid, carboxylates thereof, or a combination thereof.

84. The solution of claim 80 or 83, wherein the stabilizer is a water-miscible C₂-C₅ monocarboxylic acid, carboxylates thereof, or a combination thereof.

85. The solution of claim 84, wherein the water-miscible monocarboxylic acid is acetic acid, carboxylates thereof, or a combination thereof.

86. The solution of any one of claims 80 to 85, wherein the stabilizer is a water-miscible C₂-C₈ polycarboxylic acid, carboxylates thereof, or a combination thereof.

87. The solution of claim 86, wherein the water-miscible polycarboxylic acid is citric acid, carboxylates thereof, or a combination thereof.

88. The solution of any one of claims 80 to 88, wherein the stabilizer is <50% (vol/vol), or ≤20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the leach solution.

89. The solution of any one of claims 80 to 88, wherein the leaching acid is an acid having a first pKₐ≤1, or <0.

90. The solution of any one of claims 80 to 89, wherein the leaching acid is H₂SO₄, HNO₃, or a combination thereof.

91. The solution of any one of claims 80 to 90, wherein the leaching acid is H₂SO₄.

92. The solution of claim 91, wherein the H₂SO₄ is at a concentration of about 0.01M to about 5M, or about 0.01M to about 2M, or about 0.01M to about 1M, or about 0.01M to about 0.5M.

93. The solution of any one of claims 80 to 90, wherein the leaching acid is HNO₃ at a concentration of <2M, or about 1M to about 2M, or <1M.

94. The solution of any one of claims 80 to 93, wherein the leaching acid is not HNO₃.

95. The solution of any one of claims 80 to 94, wherein the oxidizing agent has a standard reduction potential of ≥0.6V, ≥0.65V or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V.

96. The solution of any one of claims 80 to 92, wherein the oxidizing agent is CuCl₂, FeCl₃, MnO₂, KMnO₄, H₂O₂, Fe₂(SO₄)₃, or a combination thereof.

97. The solution of any one of claims 80 to 96, wherein the oxidizing agent is H₂O₂ or Fe₂(SO₄)₃, or a combination thereof.

98. The solution of any one of claims 80 to 97, wherein the oxidizing agent is H₂O₂.

99. The solution of claim 98, wherein the H₂O₂ is about is about 1% to about 20% (vol/vol), or about 5% to about 15% (vol/vol), or about 10% to about 15% (vol/vol), or about 15% (vol/vol) of the leach solution.

100. The solution of any one of claims 80 to 97, wherein the oxidizing agent is Fe₂(SO₄)₃.

101. The solution of claim 100, wherein the Fe₂(SO₄)₃ is about 0.1% to about 5% (vol/vol), or about 0.1% to about 1% (vol/vol), or about 0.1% to about 0.5% (vol/vol), or about 0.3% (vol/vol) of the leach solution.

102. The solution of any one of claims 80 to 101, wherein the substance is a ground substance comprising particles having a size of ≤250 microns.

103. The solution of any one of claims 80 to 102, wherein the substance comprising coinage metal comprises ores, coinage metal-concentrates, mining concentrates (e.g., Cu and/or Ag mining concentrates), electronic waste, jewelry, automotive components, building components, tools, musical instruments, medical equipment, industrial machinery, soldering or brazing materials, soldered or brazed components, coins, solar panels, catalysts, mirror components, glass components, multilayer ceramic chip capacitor (MLCC), spent silver oxide batteries, or a combination thereof.

104. The solution of any one of claims 80 to 103, wherein the substance comprising coinage metal comprises ores, coinage metal-concentrates, mining concentrates, or electronic waste.

105. The solution of claim 104, wherein the electronic waste comprises electronic equipment or components thereof.

106. The solution of claim 104 or 105, wherein the electronic waste comprises motherboards, chip resistors, chip semiconductors, printed circuit boards, integrated circuit chips, or a combination thereof.

107. The solution of any one of claims 80 to 106, wherein the substance comprising coinage metal is a substance comprising copper and/or silver.

108. The solution of claim 107, wherein the substance comprising copper and/or silver further comprises gold, palladium, rhodium, and/or platinum, and the solution is used for selectively dissolving the copper and/or silver from the substance.

109. The solution of any one of claims 80 to 108, wherein the substance comprising copper and/or silver further comprises base metals and/or ferrous metals, and the solution is used for leaching the base metals and/or ferrous metals from the substance comprising coinage metal.

110. The solution of any one of claims 80 to 109, wherein the leached coinage metal is copper.

111. The solution of any one of claims 80 to 110, wherein the leached coinage metal is silver.

112. The solution of any one of claims 80 to 111, wherein the leached coinage metal is copper and silver.

113. A method of leaching coinage metal from a substance comprising coinage metal, the method comprising:
(i) contacting the substance with a first aqueous leach solution comprising:
(a) a first leaching acid;
(b) a first oxidizing agent; and
(c) a first water-miscible stabilizer,
under conditions to leach a first coinage metal from the substance; and
(ii) contacting the substance with a second aqueous leach solution comprising:
(a) a second leaching acid;
(b) a second oxidizing agent; and
(c) a second water-miscible stabilizer,
under conditions to leach a second coinage metal from the substance.

114. The method of claim 113, wherein each of the first leaching acid, first oxidizing agent, and first water-miscible stabilizer is a different chemical compound; and/or wherein each of the second leaching acid, second oxidizing agent, and second water-miscible stabilizer is a different chemical compound.

115. The method of claim 113 or 114, wherein the first stabilizer and/or the second stabilizer is a water-miscible carboxylic acid having a first pKₐ≥3.

116. The method of any one claims 113 to 115, wherein the first stabilizer and/or the second stabilizer is a water-miscible monocarboxylic acid, water-miscible polycarboxylic acid, carboxylates thereof, or a combination thereof.

117. The method of any one claims 113 to 116, wherein the first stabilizer and/or the second stabilizer is a water-miscible C₂-C₅ monocarboxylic acid, carboxylates thereof, or a combination thereof.

118. The method of claim 117, wherein the water-miscible monocarboxylic acid is acetic acid, carboxylates thereof, or a combination thereof.

119. The method of any one claims 113 to 118, wherein the first stabilizer and/or the second stabilizer is a water-miscible C₂-C₈ polycarboxylic acid, carboxylates thereof, or a combination thereof.

120. The method of claim 119, wherein the water-miscible polycarboxylic acid is citric acid, or carboxylates thereof, or a combination thereof.

121. The method of any one of claims 113 to 120, wherein the first stabilizer is <50% (vol/vol), or ≥20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the first leach solution; and/or the second stabilizer is <50% (vol/vol), or ≥20% (vol/vol), or about 1% to about 20% (vol/vol), or about 3% to about 20% (vol/vol), or about 5% to about 20% (vol/vol), or about 10% to about 20% (vol/vol), or about 15% to about 20% (vol/vol) of the second leach solution.

122. The method of any one of claims 113 to 121, wherein the first leaching acid and/or the second leaching acid is an acid having a first pKₐ≤1, or <0.

123. The method of any one of claims 113 to 122, wherein the first leaching acid and/or the second leaching acid is H₂SO₄, HNO₃, or a combination thereof.

124. The method of any one of claims 113 to 123, wherein the first leaching acid and/or the second leaching acid is H₂SO₄.

125. The method of claim 124, wherein the H₂SO₄ is at a concentration of about 0.01M to about 5M, or about 0.01M to about 2M, or about 0.01M to about 1M, or about 0.01M to about 0.5M.

126. The method of any one of claims 113 to 123, wherein the first leaching acid and/or the second leaching acid is HNO₃ at a concentration of <2M, or about 1M to about 2M, or <1M.

127. The method of any one of claims 113 to 126, wherein the first leaching acid and/or the second leaching acid is not HNO₃.

128. The method of any one of claims 113 to 127, wherein the first oxidizing agent and/or the second oxidizing agent has a standard reduction potential of ≥0.6V, ≥0.65V or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V.

129. The method of any one of claims 113 to 128, wherein the first oxidizing agent and/or the second oxidizing agent is CuCl₂, FeCl₃, MnO₂, KMnO₄, H₂O₂, Fe₂(SO₄)₃, or a combination thereof.

130. The method of any one of claims 113 to 129, wherein the first oxidizing agent and/or the second oxidizing agent is H₂O₂ or Fe₂(SO₄)₃.

131. The method of any one of claims 113 to 130, wherein the first oxidizing agent and/or the second oxidizing agent is H₂O₂.

132. The method of claim 131, wherein the H₂O₂ is about 1% to about 15% (vol/vol), or about 5% to about 15% (vol/vol), or about 10% to about 15% (vol/vol), or about 15% (vol/vol) of the first leach solution and/or the second leach solution.

133. The method of any one of claims 113 to 130, wherein the first oxidizing agent and/or the second oxidizing agent is Fe₂(SO₄)₃.

134. The method of claim 133, wherein the Fe₂(SO₄)₃ is about 0.1% to about 5% (vol/vol), or about 0.1% to about 1% (vol/vol), or about 0.1% to about 0.5% (vol/vol), or about 0.3% (vol/vol) of the first leach solution and/or the second leach solution.

135. The method of any one of claims 113 to 134, wherein the method further comprises separating the first aqueous leach solution containing the first leached coinage metal from the substance before contacting the substance with the second aqueous leach solution.

136. The method of any one of claims 113 to 135, wherein the method further comprises:
separating the first leach solution containing the first leached coinage metal from the substance;
treating the first leached coinage metal in the first leach solution under conditions to obtain the first coinage metal; and
separating the first coinage metal from the leach solution.

137. The method of any one of claims 113 to 136, wherein the method further comprises:
separating the second leach solution containing the second leached coinage metal from the substance;
treating the second leached coinage metal in the second leach solution under conditions to obtain the second coinage metal; and
separating the second coinage metal from the leach solution.

138. The method of claim 136 or 137, wherein the conditions for treating the first leached coinage metal and/or the second leached coinage metal comprise reduction, electrowinning, ion exchange, metal-salt precipitation, or a combination thereof.

139. The method of claim 138, wherein the conditions for treating comprise electrowinning.

140. The method of any one of claims 113 to 139, wherein the conditions to leach the first coinage metal from the substance comprises contacting the substance and the first aqueous leach solution at ambient temperature and/or pressure.

141. The method of any one of claims 113 to 140, wherein the conditions to leach the first coinage metal from the substance comprises contacting the substance and the first aqueous leach solution at a temperature between about 20° C. to <80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.

142. The method of any one of claims 113 to 141, wherein the conditions to leach the first coinage metal from the substance comprises contacting the substance and the first aqueous leach solution at a solid to liquid ratio of about 1:4, or about 1:5, or about 1:6, or about or about 1:7, or about 1:8, or about 1:9, or about 1:10.

143. The method of any one of claims 113 to 142, wherein the conditions to leach the first coinage metal from the substance comprises contacting the substance and the first aqueous leach solution for a time of about 0.5 hours to about 6 hours, or about 1 hour to about 6 hours, or about 1 hour or about 3 hours, or about 1 hour to about 2 hours.

144. The method of any one of claims 113 to 143, wherein the conditions to leach the second coinage metal from the substance comprises contacting the substance and the second aqueous leach solution at ambient temperature and/or pressure.

145. The method of any one of claims 113 to 144, wherein the conditions to leach the second coinage metal from the substance comprises contacting the substance and the second aqueous leach solution at a temperature between about 20° C. to <80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.

146. The method of any one of claims 113 to 145, wherein the conditions to leach the second coinage metal from the substance comprises contacting the substance and the second aqueous leach solution at a solid to liquid ratio of about 1:4, or about 1:5, or about 1:6, or about or about 1:7, or about 1:8, or about 1:9, or about 1:10.

147. The method of any one of claims 113 to 146, wherein the conditions to leach the second coinage metal from the substance comprises contacting the substance and the second aqueous leach solution for a time of about 0.5 hours to about 6 hours, or about 1 hour to about 6 hours, or about 1 hour or about 3 hours, or about 1 hour to about 2 hours.

148. The method of any one of claims 113 to 147, wherein the first coinage metal has standard reduction potential (E⁰_{CM1}), the second coinage metal has standard reduction potential E⁰_{CM2}, and E⁰_{CM2}>E⁰_{CM1}.

149. The method of any one of claims 113 to 148, further comprising grinding the substance into particles having a size of 250 microns.

150. The method of any one of claims 113 to 149, wherein the substance comprising coinage metal comprises ores, coinage metal-concentrates, mining concentrates (e.g., Cu and/or Ag mining concentrates), electronic waste, jewelry, automotive components, building components, tools, musical instruments, medical equipment, industrial machinery, soldering or brazing materials, soldered or brazed components, coins, solar panels, catalysts, mirror components, glass components, multilayer ceramic chip capacitor (MLCC), spent silver oxide batteries, or a combination thereof.

151. The method of any one of claims 113 to 150, wherein the substance comprising coinage metal comprises ores, coinage metal-concentrates, mining concentrates, or electronic waste.

152. The method of claim 150 or 151, wherein the electronic waste comprises electronic equipment or components thereof.

153. The method of any one of claims 150 to 152, wherein the electronic waste comprises motherboards, chip resistors, chip semiconductors, printed circuit boards, integrated circuit chips, or a combination thereof.

154. The method of any one of claims 113 to 153, wherein the substance comprising coinage metal is a substance comprising copper and silver.

155. The method of claim 154, wherein the substance comprising copper and silver further comprises gold, palladium, rhodium, and/or platinum, and the method selectively dissolves the copper and silver from the substance.

156. The method of any one of claims 113 to 155, further comprising leaching base metals and/or ferrous metals from the substance comprising coinage metal.

157. The method of any one of claims 113 to 156, wherein the first leached coinage metal is copper.

158. The method of any one of claims 113 to 157, wherein the second leached coinage metal is silver.

159. The method of any one of claims 113 to 158, further comprising regenerating the first oxidizing agent and/or second oxidizing agent.

160. The method of any one of claims 113 to 159, wherein the first oxidizing agent and/or second oxidizing agent is regenerated in-situ, optionally for re-use of the first and/or second aqueous leach solution.

161. The method of claim 159 or 160, wherein the first oxidizing agent and/or second oxidizing agent is at least partially reduced and regenerating the first oxidizing agent and/or second oxidizing agent comprises contacting the at least partially reduced oxidizing agent with an aqueous oxidizing solution comprising:
(a) an oxidant;
(b) an acid; and
(c) optionally a water-miscible stabilizer;
under conditions to oxidize the at least partially reduced oxidizing agent to regenerate the first oxidizing agent and/or second oxidizing agent.

162. The method of claim 161, wherein each of the oxidant, acid, and water-miscible stabilizer is a different chemical compound.

163. The method of claim 161 or 162, wherein the oxidant has a third standard reduction potential (E^{O}₃), the first oxidizing agent and/or second oxidizing agent has a fourth standard reduction potential (E^{O}₄), and E^{O}₃>E^{O}₄.

164. The method of claim 163, wherein oxidant has a standard reduction potential (E^{O}₃)≥0.6V, ≥0.65V, or ≥0.7V, or ≥0.8V, or ≥0.9V, or ≥1V, or ≥1.1V, or ≥1.2V, or ≥1.3V, or ≥1.4V, or ≥1.5V, or ≥1.6V, or ≥1.7V, or ≥1.8V, or ≥2V.

165. The method of any one of claims 161 to 164, wherein the oxidant comprises FeCl₃, MnO₂, KMnO₄, H₂O₂, Fe₂(SO₄)₃, or any combination thereof

166. The method of claim 165, wherein the oxidant is MnO₂, KMnO₄, H₂O₂, or a combination thereof.

167. The method of claim 166, wherein the oxidant is H₂O₂.

168. The method of any one of claims 161 to 167, wherein the acid is an acid having at least one pKₐ≤1, or <0.

169. The method of claim 168, wherein the acid is H₂SO₄, HNO₃, or a combination thereof.

170. The method of claim 169, wherein the acid is H₂SO₄.

171. The method of any one of claims 161 to 170, wherein the stabilizer is a water-miscible carboxylic acid having a first pKₐ≥3.

172. The method of claim 171, wherein the stabilizer is a water-miscible monocarboxylic acid, water-miscible polycarboxylic acid, carboxylates thereof, or a combination thereof.

173. The method of claim 171 or 172, wherein the stabilizer is a water-miscible C₂-C₅ monocarboxylic acid, carboxylates thereof, or a combination thereof; wherein preferably the water-miscible monocarboxylic acid is acetic acid, carboxylates thereof, or a combination thereof.

174. The method of any one of claims 171 to 173, wherein the stabilizer is a water-miscible C₂-C₈ polycarboxylic acid, carboxylates thereof, or a combination thereof; wherein preferably the water-miscible polycarboxylic acid is citric acid, carboxylates thereof, or a combination thereof.

175. The method of any one of claims 161 to 174, wherein the conditions comprise contacting the at least partially reduced oxidizing agent with the aqueous oxidizing solution at ambient temperature and pressure.

176. The method of any one of claims 161 to 175, wherein the conditions comprise contacting the at least partially reduced oxidizing agent with the aqueous oxidizing solution at a temperature between about 20° C. to about 80° C., or about 20° C. to about 70° C., or about 20° C. to about 60° C., or about 20° C. to about 50° C., or about 20° C. to about 60° C., or about 20° C. to about 50° C., or about 20° C. to about 40° C., or about 20° C. to about 30° C., or about 20° C. to about 25° C.; or about 16° C. to about 25° C.

177. The method of any one of claims 161 to 176, wherein the conditions to oxidize the at least partially reduced oxidizing agent to regenerate the first oxidizing agent and/or second oxidizing agent comprise contacting the at least partially reduced oxidizing agent with the aqueous oxidizing solution for a time of about 1 min to about 1 hour, or about 5 min to about 45 min, or about 10 min to about 30 min.

178. The method of any one of claims 113 to 177, wherein the leaching yield of the first coinage metal and/or the second coinage metal is >65%, >70%, or >75%, or >80%, or >85%, or >90%, or >95%, or >98%, or >99%; preferably >80%, or >85%, >90%, or >95%, or >98%, or >99%.

179. The method of any one of claims 113 to 178, wherein the method has leaching yield (Y₁) of the first coinage metal and/or the second coinage metal, an incumbent leaching process has leaching yield (Y₂) of the first coinage metal and/or the second coinage metal, and the difference in leaching yield (Y₁−Y₂) is about 10% to about 90%, or about 12% to about 90%, or about 15% to about 90%, or about 20% to about 90%, or about 30% to about 90%, or about 40% to about 90%, or about 45% to about 90%, or about 50% to about 90%.

180. The method of any one of claims 113 to 179, wherein the method has leaching yield (Y₁) of the first coinage metal and/or the second coinage metal, an incumbent leaching process has leaching yield (Y₂) of the first coinage metal and/or the second coinage metal, and the percent increase in leaching yield [(Y₁−Y₂)/|Y₂|]×100) is about 10% to about 1500%, or about 20% to about 1200%, or about 20% to about 1100%, or about 20% to about 1000%, or about 20% to about 900%, or about 20% to about 800%, or about 20% to about 700%, or about 20% to about 600%, or about 20% to about 500%, or about 20% to about 400%, or about 20% to about 300%, or about 20% to about 250%, or about 20% to about 200%, or about 20% to about 100%, or about 20% to about 70%, or about 20% to about 60%, or about 20% to about 50%, or about 20% to about 40%, or about 20% to about 30%.
